(19) United States
(12) Patent Application Publication
(10) Pub. No.: US 2024/0188064 A1
(43) Pub. Date: Jun. 6, 2024

(54) META-SURFACE ENABLED MULTIPLE ACCESS CONTROL

(71) Applicant: QUALCOMM Incorporated, San Diego, CA (US)

(72) Inventors: Sourjya Dutta, San Diego, CA (US); Kapil Gulati, Belle Mead, NJ (US); Navid Abedini, Basking Ridge, NJ (US)

(21) Appl. No.: 18/073,325

(22) Filed: Dec. 1, 2022

(51) Int. Cl. H04W 72/121; H04W 72/1268; H04W 72/25

(52) U.S. Cl. CPC H04W 72/121; H04W 72/1268; H04W 72/25

(57) ABSTRACT

Methods, systems, and devices for wireless communications are described. A device may receive a sidelink grant for forwarding a combined uplink grant to a plurality of user equipments (UEs). The device may transmit, based on the combined uplink grant, individual uplink grants to the plurality of UEs in accordance with the sidelink grant. The device may configure, via a control signal, a meta-surface to redirect one or more uplink transmissions from the plurality of UEs to the network entity in accordance with the individual uplink grants.

### FIELD OF TECHNOLOGY

The following relates to wireless communications, including meta-surface enabled multiple access control.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may operate in a multiple access scheme. However, such approaches may be improved.

### SUMMARY

The described techniques relate to improved methods, systems, devices, and apparatuses that support meta-surface enabled multiple access control. For example, a device (e.g., a meta-surface controller or reconfigurable intelligent device (RID) controller (RID-C)) may receive a sidelink grant for forwarding a combined uplink grant to a plurality of user equipments (UEs). The device may transmit, based on the combined uplink grant, individual uplink grants to the plurality of UEs in accordance with the sidelink grant. The device may configure, via a control signal, a meta-surface to redirect one or more uplink transmissions from the plurality of UEs to the network entity in accordance with the individual uplink grants.

A method for wireless communication at a device is described. The method may include receiving, from a network entity via an access link, a sidelink grant for forwarding a combined uplink grant to a set of multiple user equipments (UEs), transmitting, based on the combined uplink grant, individual uplink grants to the set of multiple user equipment (UE)s in accordance with the sidelink grant, and configuring, via a control signal, a meta-surface to redirect one or more uplink transmissions from the set of multiple UEs to the network entity in accordance with the individual uplink grants.

An apparatus for wireless communication at a device is described. The apparatus may include a processor, memory coupled with the processor, and instructions stored in the memory. The instructions may be executable by the processor to cause the apparatus to receive, from a network entity via an access link, a sidelink grant for forwarding a combined uplink grant to a set of multiple user equipments (UEs), transmit, based on the combined uplink grant, individual uplink grants to the set of multiple UEs in accordance with the sidelink grant, and configuring, via a control signal, a meta-surface to redirect one or more uplink transmissions from the set of multiple UEs to the network entity in accordance with the individual uplink grants.

Another apparatus for wireless communication at a device is described. The apparatus may include means for receiving, from a network entity via an access link, a sidelink grant for forwarding a combined uplink grant to a set of multiple user equipments (UEs), means for transmitting, based on the combined uplink grant, individual uplink grants to the set of multiple UEs in accordance with the sidelink grant, and means for configuring, via a control signal, a meta-surface to redirect one or more uplink transmissions from the set of multiple UEs to the network entity in accordance with the individual uplink grants.

A non-transitory computer-readable medium storing code for wireless communication at a device is described. The code may include instructions executable by a processor to receive, from a network entity via an access link, a sidelink grant for forwarding a combined uplink grant to a set of multiple user equipments (UEs), transmit, based on the combined uplink grant, individual uplink grants to the set of multiple UEs in accordance with the sidelink grant, and configuring, via a control signal, a meta-surface to redirect one or more uplink transmissions from the set of multiple UEs to the network entity in accordance with the individual uplink grants.

Some examples of the method, apparatuses, and non-transitory computer-readable medium described herein may further include operations, features, means, or instructions for transmitting, to the network entity via the access link, an indication of the set of multiple UEs associated with the meta-surface and receiving, from the network entity via the access link, a combined uplink grant for the set of multiple UEs.

Some examples of the method, apparatuses, and non-transitory computer-readable medium described herein may further include operations, features, means, or instructions for transmitting, to the network entity via the access link, a request to enable a multiple access communication scheme for the set of multiple UEs via the meta-surface and receiving, based on the request, a response message indicating that the multiple access communication scheme may be enabled for the set of multiple UEs, where transmitting the individual uplink grants may be based on receiving the response message.

In some examples of the method, apparatuses, and non-transitory computer-readable medium described herein, the request further includes an identifier associated with the device, an identifier associated with the set of multiple UEs, one or more identifiers for individual UEs of the set of multiple UEs, or any combination thereof.

In some examples of the method, apparatuses, and non-transitory computer-readable medium described herein, the request further includes one or more channel measurement reports for one or more channels between the meta-surface and one or more UEs of the set of multiple UEs.

Some examples of the method, apparatuses, and non-transitory computer-readable medium described herein may further include operations, features, means, or instructions for transmitting, to the set of multiple UEs and based on the response message, an indication that meta-surface enabled multiple access for the set of multiple UEs may have been enabled.

Some examples of the method, apparatuses, and non-transitory computer-readable medium described herein may further include operations, features, means, or instructions for transmitting an indication of a multiple access scheme associated with the set of multiple UEs.

In some examples of the method, apparatuses, and non-transitory computer-readable medium described herein, the combined uplink grant includes an indication of a bandwidth part associated with the combined uplink grant, an indication of a common resource allocation, an identifier associated with the set of multiple UEs, a list of UEs of the set of multiple UEs that may be scheduled by the combined uplink grant, a list of modulation and coding scheme orders for each UE of the list of UEs being scheduled by the combined uplink grant, an indication of the sidelink grant, or any combination thereof.

In some examples of the method, apparatuses, and non-transitory computer-readable medium described herein, the individual uplink grants indicate a bandwidth part for the one or more uplink transmissions, a common resource allocation for the one or more uplink transmissions, precoding information for the one or more uplink transmissions, or any combination thereof.

Some examples of the method, apparatuses, and non-transitory computer-readable medium described herein may further include operations, features, means, or instructions for receiving one or more measurement reports for one or more channels associated with the set of multiple UEs and the meta-surface and transmitting, to the network entity via the access link, an indication of the set of multiple UEs associated with the meta-surface, where the indication of the set of multiple UEs includes an indication of a multiple access group that includes the set of multiple UEs based on the one or more measurement reports.

Some examples of the method, apparatuses, and non-transitory computer-readable medium described herein may further include operations, features, means, or instructions for transmitting, to the network entity via the access link, an indication of the set of multiple UEs associated with the meta-surface and receiving one or more cell-specific identifiers associated with the set of multiple UEs and one or more cell identifiers associated with the set of multiple UEs, where the indication of the set of multiple UEs includes an indication of a multiple access group that includes the set of multiple UEs based on the one or more cell-specific identifiers and the one or more cell identifiers.

Some examples of the method, apparatuses, and non-transitory computer-readable medium described herein may further include operations, features, means, or instructions for receiving, from the set of multiple UEs, one or more meta-surface configurations for individual UEs of the set of multiple UEs and where the control signal indicating to redirect the one or more uplink transmissions may be based on the one or more meta-surface configurations.

In some examples of the method, apparatuses, and non-transitory computer-readable medium described herein, the device may be a meta-surface controller.

A method for wireless communications at a network entity is described. The method may include receiving, from a device via an access link, an indication of a set of multiple user equipments (UEs) associated with a meta-surface controlled by the device, transmitting, via the access link, a combined uplink grant for the set of multiple UEs, transmitting, to the device via the access link, a sidelink grant for relay by the device to the set of multiple UEs, and monitoring for one or more uplink transmissions from the set of multiple UEs via the meta-surface in accordance with the combined uplink grant.

An apparatus for wireless communications at a network entity is described. The apparatus may include a processor, memory coupled with the processor, and instructions stored in the memory. The instructions may be executable by the processor to cause the apparatus to receive, from a device via an access link, an indication of a set of multiple user equipments (UEs) associated with a meta-surface controlled by the device, transmit, via the access link, a combined uplink grant for the set of multiple UEs, transmit, to the device via the access link, a sidelink grant for relay by the device to the set of multiple UEs, and monitor for one or more uplink transmissions from the set of multiple UEs via the meta-surface in accordance with the combined uplink grant.

Another apparatus for wireless communications at a network entity is described. The apparatus may include means for receiving, from a device via an access link, an indication of a set of multiple user equipments (UEs) associated with a meta-surface controlled by the device, means for transmitting, via the access link, a combined uplink grant for the set of multiple UEs, means for transmitting, to the device via the access link, a sidelink grant for relay by the device to the set of multiple UEs, and means for monitoring for one or more uplink transmissions from the set of multiple UEs via the meta-surface in accordance with the combined uplink grant.

A non-transitory computer-readable medium storing code for wireless communications at a network entity is described. The code may include instructions executable by a processor to receive, from a device via an access link, an indication of a set of multiple user equipments (UEs) associated with a meta-surface controlled by the device, transmit, via the access link, a combined uplink grant for the set of multiple UEs, transmit, to the device via the access link, a sidelink grant for relay by the device to the set of multiple UEs, and monitor for one or more uplink transmissions from the set of multiple UEs via the meta-surface in accordance with the combined uplink grant.

Some examples of the method, apparatuses, and non-transitory computer-readable medium described herein may further include operations, features, means, or instructions for receiving a request to enable meta-surface enabled multiple access for the set of multiple UEs, the request including the indication of the set of multiple UEs and transmitting, based on the indication of the set of multiple UEs, a response message enabling the meta-surface enabled multiple access for the set of multiple UEs.

In some examples of the method, apparatuses, and non-transitory computer-readable medium described herein, the request further includes an identifier associated with the device, an identifier associated with the set of multiple UEs, one or more identifiers for individual UEs of the set of multiple UEs, or any combination thereof.

In some examples of the method, apparatuses, and non-transitory computer-readable medium described herein, the request further includes one or more channel measurement reports for one or more channels between the meta-surface and the set of multiple UEs.

Some examples of the method, apparatuses, and non-transitory computer-readable medium described herein may further include operations, features, means, or instructions for receiving an indication of a multiple access scheme associated with the set of multiple UEs.

In some examples of the method, apparatuses, and non-transitory computer-readable medium described herein, the combined uplink grant includes an indication of a bandwidth part associated with the combined uplink grant, an indication of a common resource allocation, an identifier associated with the set of multiple UEs, a list of UEs of the set of multiple UEs that may be scheduled by the combined uplink grant, a list of modulation and coding scheme orders for each UE of the list of UEs being scheduled by the combined uplink grant, an indication of the sidelink grant, or any combination thereof.

In some examples of the method, apparatuses, and non-transitory computer-readable medium described herein, the one or more uplink transmissions include multiple uplink transmissions and the method, apparatuses, and non-transitory computer-readable medium may include further operations, features, means, or instructions for performing a successive interference cancelation process on the multiple uplink transmissions to decode one or more of the multiple uplink transmissions.

A method for wireless communication at a UE is described. The method may include transmitting, to a device, a channel measurement report indicating a channel measurement of a channel between the UE and a meta-surface associated with the device, monitoring for an uplink grant for transmissions that are to be redirected from the UE to a network entity by the meta-surface, and transmitting an uplink transmission in accordance with the uplink grant.

An apparatus for wireless communication at a UE is described. The apparatus may include a processor, memory coupled with the processor, and instructions stored in the memory. The instructions may be executable by the processor to cause the apparatus to transmit, to a device, a channel measurement report indicating a channel measurement of a channel between the UE and a meta-surface associated with the device, monitor for an uplink grant for transmissions that are to be redirected from the UE to a network entity by the meta-surface, and transmit an uplink transmission in accordance with the uplink grant.

Another apparatus for wireless communication at a UE is described. The apparatus may include means for transmitting, to a device, a channel measurement report indicating a channel measurement of a channel between the UE and a meta-surface associated with the device, means for monitoring for an uplink grant for transmissions that are to be redirected from the UE to a network entity by the meta-surface, and means for transmitting an uplink transmission in accordance with the uplink grant.

A non-transitory computer-readable medium storing code for wireless communication at a UE is described. The code may include instructions executable by a processor to transmit, to a device, a channel measurement report indicating a channel measurement of a channel between the UE and a meta-surface associated with the device, monitor for an uplink grant for transmissions that are to be redirected from the UE to a network entity by the meta-surface, and transmit an uplink transmission in accordance with the uplink grant.

Some examples of the method, apparatuses, and non-transitory computer-readable medium described herein may further include operations, features, means, or instructions for receiving a notification that uplink multiple access communications may be enabled for a set of multiple UEs that includes the UE, where monitoring for the uplink grant may be based on receiving the notification.

Some examples of the method, apparatuses, and non-transitory computer-readable medium described herein may further include operations, features, means, or instructions for receiving, via a sidelink channel, a channel measurement request indicating a sidelink resource for the channel measurement.

In some examples of the method, apparatuses, and non-transitory computer-readable medium described herein, the channel measurement report indicates a requested meta-surface configuration for the meta-surface based on the channel measurement.

Some examples of the method, apparatuses, and non-transitory computer-readable medium described herein may further include operations, features, means, or instructions for receiving, in accordance with a sidelink grant, the uplink grant from the device.

In some examples of the method, apparatuses, and non-transitory computer-readable medium described herein, the uplink grant includes an indication of a bandwidth part associated with the uplink grant, an indication of a common resource allocation common to a set of multiple UEs that includes the UE, precoding information for the uplink transmission, or any combination thereof.

Some examples of the method, apparatuses, and non-transitory computer-readable medium described herein may further include operations, features, means, or instructions for transmitting a cell-specific identifier associated with the UE and a cell identifier associated with the UE.

### BRIEF DESCRIPTION OF THE DRAWINGS

FIG. 1 illustrates an example of a wireless communications system that supports meta-surface enabled multiple access control in accordance with one or more examples as disclosed herein.

FIG. 2 illustrates an example of a wireless communications system that supports meta-surface enabled multiple access control in accordance with one or more examples as disclosed herein.

FIG. 3 illustrates an example of a process flow that supports meta-surface enabled multiple access control in accordance with one or more examples as disclosed herein.

FIG. 4 illustrates an example of a process flow that supports meta-surface enabled multiple access control in accordance with one or more examples as disclosed herein.

FIG. 5 illustrates an example of a process flow that supports meta-surface enabled multiple access control in accordance with one or more examples as disclosed herein.

FIGS. 6 and 7 illustrate block diagrams of devices that support meta-surface enabled multiple access control in accordance with one or more examples as disclosed herein.

FIG. 8 illustrates a block diagram of a communications manager that supports meta-surface enabled multiple access control in accordance with one or more examples as disclosed herein.

FIG. 9 illustrates a diagram of a system including a device that supports meta-surface enabled multiple access control in accordance with one or more examples as disclosed herein.

FIGS. 10 and 11 illustrate block diagrams of devices that support meta-surface enabled multiple access control in accordance with one or more examples as disclosed herein.

FIG. 12 illustrates a block diagram of a communications manager that supports meta-surface enabled multiple access control in accordance with one or more examples as disclosed herein.

FIG. 13 illustrates a diagram of a system including a device that supports meta-surface enabled multiple access control in accordance with one or more examples as disclosed herein.

FIGS. 14 and 15 illustrate block diagrams of devices that support meta-surface enabled multiple access control in accordance with one or more examples as disclosed herein.

FIG. 16 illustrates a block diagram of a communications manager that supports meta-surface enabled multiple access control in accordance with one or more examples as disclosed herein.

FIG. 17 illustrates a diagram of a system including a device that supports meta-surface enabled multiple access control in accordance with one or more examples as disclosed herein.

FIGS. 18 through 20 illustrate flowcharts showing methods that support meta-surface enabled multiple access control in accordance with one or more examples as disclosed herein.

### DETAILED DESCRIPTION

In some wireless communications systems involving multiple devices, multiple access (MA) scheme may be employed, including non-orthogonal multiple access (NOMA) schemes in which two or more devices transmit over the same resources and a receiving device may perform successive interference cancelation. Some such NOMA schemes may further include the use of a meta-surface (also referred to as a reconfigurable intelligent device (RID)) that may anomalously (e.g., without obeying general laws of optics, such as Snell's law) reflect, refract, or otherwise redirect incident wavefronts. By using a meta-surface, an uplink channel in a NOMA scheme may be altered to redirect NOMA uplink transmissions (e.g., to provide improved communication conditions that may be more suitable for NOMA). However, previous approaches to NOMA communications have not discussed any control mechanisms for a meta-surface and a meta-surface controller (also referred to as a RID controller (RID-C)) to enable MA in this way.

The subject matter discussed herein includes control mechanisms for a meta-surface controller to manage enhanced multiple access for a wireless communications system using the meta-surface. Such control mechanisms may involve coordination between a meta-surface controller, a network entity, and one or more UEs that are to transmit uplink transmissions in NOMA. The meta-surface controller may discover a group of UEs that are capable of communicating in NOMA using the meta-surface, and may transmit an indication of the group to a network entity. Such UEs may be spatially separated around the meta-surface, the network entity, or both. The network entity may then transmit a combined uplink grant for the group of UEs and a sidelink grant so that the meta-surface controller may generate and transmit individual uplink grants to the UEs. The UEs may then transmit their respective uplink messages (e.g., in accordance with a NOMA scheme) to the meta-surface which may redirect one or more of the uplink transmissions to the network entity, thereby effectively re-grouping the uplink transmissions to be received in a single effective spatial direction at the network entity (as opposed to the directions of the spatially separated UEs). The network entity may then decode the one or more uplink transmissions using a successive interference cancelation (SIC) technique.

In at least these ways, the use of the meta-surface controller and the meta-surface may increase system capacity of the wireless communications network, because the meta-surface controller may alter one or more conditions of the channel that may make NOMA feasible when it may not have been feasible otherwise. The use of the meta-surface controller and the meta-surface also provide additional degrees of control over uplink transmissions due to configuration or modification of the meta-surface controller's characteristics to alter characteristics of the uplink signals that are redirected by the meta-surface. For example, the system may control an achievable rate of the MA system by adjusting the characteristics of the meta-surface. Further, by using the meta-surface to enable a NOMA scenario, coverage may be enhanced and the probability of outages is reduced. Additionally, or alternatively, radio resources may be better utilized (e.g., more efficiently) due to the consolidation of spatial directions of uplink transmissions from spatially separated UEs into fewer spatial directions from which the network entity receives the uplink transmissions.

Aspects of the disclosure are initially described in the context of wireless communications systems. Aspects of the disclosure are then described with reference to a wireless communications system and process flows. Aspects of the disclosure are further illustrated by and described with reference to apparatus diagrams, system diagrams, and flowcharts that relate to meta-surface enabled multiple access control.

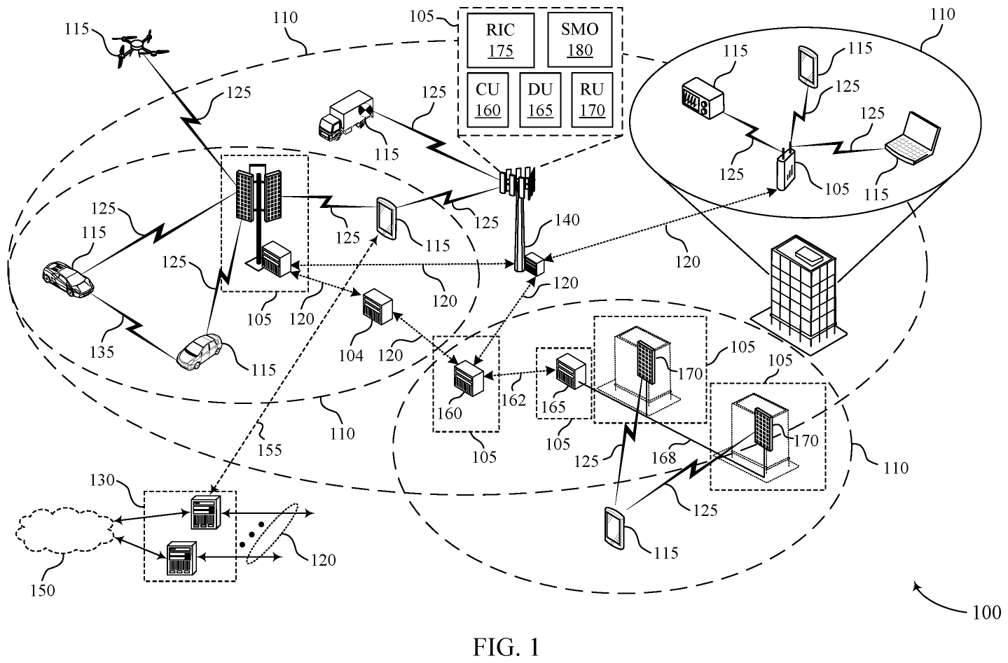

FIG. 1 illustrates an example of a wireless communications system 100 that supports meta-surface enabled multiple access control in accordance with one or more examples as disclosed herein. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support meta-surface enabled multiple access control as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the RID-C may receive a sidelink grant for forwarding a combined uplink grant to group of UEs 115 that may operate in a MA scheme (e.g., a NOMA scheme) using a RID to manipulate or control transmissions from multiple UEs 115. The device may transmit individual uplink grants to the plurality of UEs 115 for uplink transmissions that may utilize the RID to communicate with the network entity 105. The device may further configure the RID to redirect (e.g., reflect, refract, or both) one or more uplink transmissions from the plurality of UEs 115 to the network entity in accordance with the individual uplink grants. In this way, the wireless communications system 100 may engage in an MA scheme (e.g., a NOMA scheme) and may employ an additional degree of control the uplink channel by using the RID.

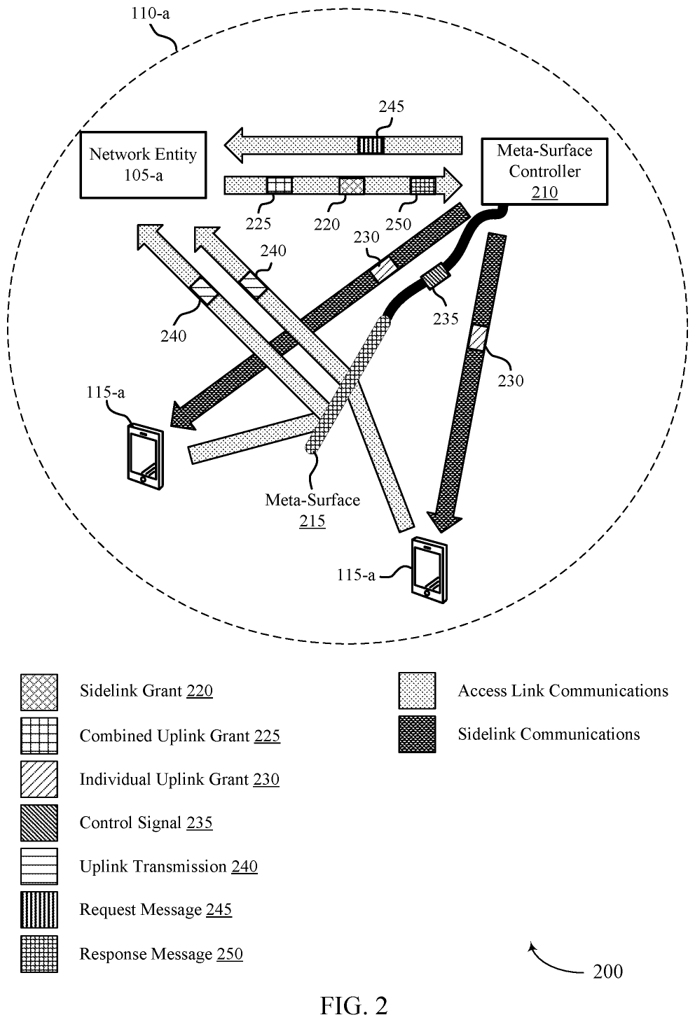

FIG. 2 illustrates an example of a wireless communications system 200 that supports meta-surface enabled multiple access control in accordance with one or more examples as disclosed herein. The wireless communications system 200 may include or involve the network entity 105-a, one or more UEs 115-a, the meta-surface controller 210, and the meta-surface 215, which may operate within a coverage area 110-a of the network entity 105-a. In some examples, the meta-surface 215 may also be referred to as a RID, and the meta-surface controller 210 may be referred to as a RID-C.

Some wireless communications systems may employ NOMA schemes in which two or more devices may use the same radio resource. For example, in downlink NOMA, the network entity 105-a may transmit in the same resource to 2 or more UEs 115-a. In uplink NOMA, two or more UEs 115-a may use the same resource to communicate with the network entity 105-a. Though discussion herein may involve uplink NOMA, some or all portions of such discussion may be applied to downlink NOMA situations as well.

In NOMA schemes, a transmitting device may encode data in the power domain (PD-NOMA). For example, a transmitted signal represented by x(t) may be expressed as x(t)=\sqrt{α₁P}x₁(t)+\sqrt{α₂P}x₂(t). A receiving device may perform successive interference cancelation (SIC) to boost signal reception quality. In such a situation, path losses from the two different UEs 115-a may be represented by |h₁|², |h₂|²; |h₁|²<|h₂|². If the transmitter selects the power fraction αᵢ, such that α₁>α₂, then: UE 2 decodes the signal for UE-1 first, cancels the interference, decodes the signal for UE-2 without interference, thereby boosting SNR and decoding rate. A UE with a weaker link (e.g., UE 1 in this example) may decode its own signal which is received with a higher power (e.g., α₁>α₂). In some examples, a transmitting device may encode by using specialized codes, sequences, or by enhanced interleaving or scrambling techniques.

Some NOMA approaches may employ the use of one or more meta-surfaces 215. A meta-surface 215 may be a specially fabricated surfaces that can transmit, refract, reflect, diffract, or otherwise alter an incident wavefront anomalously. Anomalous reflection or refraction may refer to reflection or refraction that does not obey the general laws of optics (e.g., Snell's Law). In the context of wireless communications a wireless channel involving the meta-surface 215 (e.g., between a transmitting device, such as a UE 115-a, and a receiving device, such as the network entity 105-a, may be determined by the reflections, refraction, diffractions, or other alterations of an electromagnetic (EM) wave passing through the meta-surface 215. Placing meta-surfaces in this medium can enable “intelligent” or controllable alteration (e.g., steering or adjustments of directionality) of the EM waves towards or away from a receiver, which may provide intelligent control of the wireless medium.

The 215 may operate in one or more modes of operation, including a reflective mode and a refracting or transmissive mode. In a reflective mode, the meta-surface 215 may reflects an EM wave in a configurable direction. In a refracting or transmissive mode, the meta-surface 215 may refract the wave front in a desired direction.

In some examples, NOMA may be enabled or improved through the use of the meta-surface 215. For example, the meta-surface 215 may be configured to work in both a transmissive or refracting mode as well as a reflective mode. For example, a first group of meta-elements of the meta-surface 215 may be configured to reflect EM waves while another group of meta-elements may be configured to refract or transmit EM waves. Such a configuration may be referred to as a simultaneous transmit and receive meta-surface or RID.

In some examples, enabling NOMA may involve conditions on the channels to be met (e.g., to allow for one or more procedures to be performed, such as SIC). For instance, as discussed in an example, herein, a situation in which path losses h₁ and h₂ are roughly equivalent (e.g., |h₁|≈|h₂|) may imply that a SIC process may fail (e.g., since the small difference between the two channels does not allow for decoding of both channels or the removal of interference). As such, the meta-surface 215 may be used to “intelligently” alter the channels to allow for SIC, NOMA, or both. In this way, the probability of outage may be decreased and coverage may be enhanced. Similar gains can be achieved by employing intelligent gain control with multi panel intelligent repeaters.

In some examples, NOMA may be employed in a power domain. For example, consider a scenario in which two UEs are transmitting uplink communications to a network entity over the same resource and the transmit powers of the UEs are the same. The signal received at the gNB represented by y(t) may be y(t)=\sqrt{P₁}h₁x₁(t)+\sqrt{P₂}h₂x₂(t)), where P₁ and P₂ represent the transmit powers of the UEs, h₁ and h₂ represent the respective channels, and x₁ (t) and x₂(t) represent the transmitted messages. In such a scenario, one of the channels may be stronger than the other, given by P₁|h₁|²>>P₂|h₂|² (P₁≤Pₘₐₓ; P₂≤Pₘₐₓ). In such a scenario, the network entity may engage in a SIC procedure in which the network entity may decode the stronger signal, subtract the signal from the received signal and then decode the weaker. For example, the UL Rate of UE 1 (stronger signal) may be given by

$${R}_{1} = {log}_{2} ( \frac{{P}_{1} {\vert {h}_{1} \vert}^{2}}{{P}_{2} {\vert {h}_{2} \vert}^{2} + {σ}_{n}^{2}} )$$

and the UL Rate of UE 2 (weaker signal) may be given by

$${R}_{2} = {log}_{2} ( \frac{{P}_{2} {\vert {h}_{2} \vert}^{2}}{{σ}_{n}^{2}} ) .$$

In such situations, the use of NOMA may enhance system capacity. However, the use of NOMA may not be always feasible. For instance, the channel conditions (h₁, h₂) may not support effective SIC. In another case, UEs engaging in beamformed communications may be spatially separated, and the network entity may serve the UEs in a TDM or SDM manner due to the spatial separation. However, a meta-surface may effectively put both the UE-s in the same spatial direction from the network entity's perspective. For example, as shown in FIG. 2, the UEs 115-a are spatially separated, but their uplink transmissions 240 arrive at the network entity 105-a in a same effective spatial direction (e.g., arriving in a direction originating from the meta-surface 215). Such a scenario may allow the network entity 105-a to multiplex the UEs 115-a using either FDMA or through NOMA. This may lead to better utilization of radio resources by addressing the issue of spatial separation of UE-s through the use of the meta-surface 215.

With a meta-surface 215 that can simultaneously support both transmissions from both UEs 115-a, the wireless communications system 200 gains the capability to alter the uplink channel in an intelligent manner. Moreover, some meta-surfaces may allow for additional degrees of control by changing channel gains (e.g., in the case of a repeater) or the transmission and reflection coefficients for a meta-surface. Additionally, or alternatively, the wireless communications system 200 may control or adjust an achievable rate of the MA or NOMA system.

The meta-surface 215 may modify the channel between a transmitting device e.g., a UE 115-a), which may enable NOMA schemes. However, the meta-surface 215 may be controlled by another device (e.g., the meta-surface controller 210). Such control may be beneficial to allow for SIC or other procedures for enhancing wireless communications. However, such control may involve communications, procedures, rules, or configurations between various devices in the wireless communications system 200, including the UEs 115-a, the meta-surface 215, the meta-surface controller 210, the network entity 105-a, one or more additional devices, or any combination thereof.

In some examples, the meta-surface controller 210 may be connected to or co-located with a wireless communication device that may communicate with one or more nodes (e.g., the UEs 115-a, the network entity 105-a, other devices, or any combination thereof) over one or more communication channels (e.g., access links, sidelink links, one or more other communication channels, or any combination thereof). For example, the meta-surface controller 210 may communicate (e.g., via the wireless communication device) with the network entity 105-a over a Uu link or access link. The meta-surface controller 210 may communicate with the UEs 115-a over one or more sidelink connections. In situations involving uplink communications from the UEs 115-a, the meta-surface controller 210 may communicate with the network entity 105-a, the UEs 115-a, or both as part of a process to configure the meta-surface 215 to alter the uplink channels as desired. For example, the meta-surface controller 210 may configure the meta-surface 215 such that the uplink transmissions 240 from the UEs 115-a may be reflected or refracted towards the network entity 105-a.

In some examples, a UE 115-a and the meta-surface controller 210 may discover one another over a sidelink connection. In the discovery phase, the UE 115-a may share with the meta-surface controller 210 one or more parameters, including an identifier (e.g., a cell specific identifier), a cell associated with the UE 115-a, or both. In some cases, the discovery message may include a list of one or more quality-of-service considerations (e.g., rate, latency, uptime, one or more other considerations, or any combination thereof) shared by the UE 115-a to the meta-surface controller 210.

In some examples, each UE 115-a may determine a meta-surface configuration that boosts or otherwise affects its channel. Such determination may be performed in a training phase in which, in some cases, may be an individual training phase for each UE 115-a. In other cases, the training phase may be a joint training phase for all UEs 115-a associated with a cell. Post training, UEs 115-a may report back the channel quality to the meta-surface 215 controller for each measurement occasion. In some examples, one measurement occasion may be associated with a meta-surface configuration. The report may include an indication of the precoding configuration used at the UE 115-a for each measurement. In some cases, the report may include one or more signal quality metrics, an indication of uplink-downlink reciprocity, or both.

In some examples, the meta-surface controller 210 may group a plurality of UEs into one or more groups for an MA scheme, optionally based on one or more configurations for each UE 115-a determined during the measurement phase. For example, the meta-surface controller 210 may group the UEs 115-a from the same cell into groups of 2 or more UEs 115-a where each member of a group may support a selected MA scheme (e.g., FDMA or NOMA) while maintaining the indicated quality-of-service considerations, if they were indicated. Additionally, or alternatively, the meta-surface controller 210 may group the UEs based on location, one or more quality-of-service considerations, or both.

For example, the UEs 115-a may be in a NOMA group and other UEs may be placed in another group. The meta-surface controller 210 may determine that the other UEs cannot be in placed in a group (e.g., a NOMA group) for one or more reasons, such as a similarity of channels between one or more devices or a selection of the same or similar meta-surface configurations.

In some examples, the meta-surface controller 210 may create or use an existing communication link (e.g., an access link or Uu link) to communicate with the network entity 105-a to indicate the UE grouping. For example, the meta-surface controller 210 may transmit a request message 245 with such information and the request message 245 may be referred to as a UL_e-MA_Enable request message. The meta-surface controller 210 may include one or more parameters for communications involving the meta-surface 215. For example, the meta-surface controller 210 may include its own identifier (e.g., a cell-specific identifier), a list of UE groups, both. In some examples, each group may be represented by a unique group identifier, one or more associated (e.g., cell specific) UE identifiers, or both. For example, in some cases, for each group (e.g., an MA group, such as an enhanced MA group), an associated MA scheme may be indicated (e.g., an FDMA scheme or a NOMA scheme).

In some cases, the meta-surface controller 210 may include, in the request, a link measurement report for the meta-surface enabled link to the network entity 105-a for each UE 115-a in a group. In some examples, such measurements may be the measurements reported by the UEs 115-a after the training phase. In some other examples, the included measurements may be link quality estimates that are based on the UE measurements, meta-surface 215 adjustments or parameters for enabling FDMA or NOMA, or any combination thereof.

The network entity 105-a may receive the request message 245 from the meta-surface controller 210 and may perform one or more actions in response. For example, the network entity 105-a may transmit a response message 250 to the meta-surface controller 210 and the response message 250 may be referred to a UL_e-MA_Enable response message. The response message 250 may indicates acceptance or rejection of the request message 245. Acceptance or rejection may be indicated for some or all of the groups indicated in the request message 245 on a collective basis or may be indicated on a per-group basis. The response message 250 may indicate to the meta-surface controller 210 whether uplink grants (e.g., the combined uplink grant 225) are to be re-processed by the meta-surface controller 210. In some such cases, a time bound or limit for processing and re-sending processed uplink grants may either be indicated to the meta-surface controller 210 (e.g., via control signaling) or may be configured. Additionally, or alternatively, the network entity 105-a may indicate to the meta-surface controller 210 (e.g., in the response message 250) one or more sidelink grants (e.g., sidelink Mode 1 grants) for coordination of the MA scheme involving the UEs 115-a and the meta-surface 215. For example, the meta-surface controller 210 may transmit sidelink messages in accordance with such sidelink grants to transmit the individual uplink grants 230 to the UEs 115-a.

In some examples, the network entity 105-a may perform one or more actions after indicating acceptance in the response message 250. The network entity 105-a may transmit, to the UEs 115-a in the accepted groups, an indication that MA has been enabled. The network entity 105-a may indicate an identifier (e.g., a cell-specific identifier) of the meta-surface controller 210 to the UEs 115-a. The network entity 105-a may indicate whether uplink grants (e.g., the individual uplink grants 230) are to be received from the meta-surface controller 210, the network entity 105-a, or both. In some examples, the meta-surface controller 210 may receive the combined uplink grant 225, generate the individual uplink grants 230 based on the combined uplink grant 225, and transmit the individual uplink grants 230 to the UEs 115-a. In other examples, the network entity 105-a may transmit one or more uplink grants to the UEs 115-a (e.g., the individual uplink grants 230 or the combined uplink grant 225).

In some examples, the network entity 105-a may configure or reconfigure one or more of the UEs 115-a with an additional delay to accommodate reception of the individual uplink grants 230. In some examples in which the MA scheme is a NOMA scheme for a group of UEs, further processing of one or more uplink grants (e.g., the combined uplink grant 225) may be performed at the meta-surface controller 210. In some examples in which the MA schema is an FDMA scheme for a group of UEs, the meta-surface controller 210 may forward one or more uplink grants received from the network entity 105-a to the UEs 115-a.

In some examples, the network entity 105-a may enable uplink grant modification for a MA scheme involving the meta-surface 215. In some examples, the network entity 105-a may generate a single uplink grant (e.g., the combined uplink grant 225) for all UEs or for a set of UEs in a MA group (optionally based on a scheduling request, a buffer status report (BSR), group information received from the meta-surface controller 210, or any combination thereof). The combined uplink grant 225 may include a BWP associated with the grant, a common time-frequency resource allocation, a group identifier (e.g., from the set of group identifiers indicated by the meta-surface controller 210), a list of UEs being scheduled (e.g., where the list includes UEs in the group indicated by the group identifier), a list of one or more modulation and coding scheme (MCS) orders for each UE being scheduled, one or more additional uplink grant parameters, or any combination thereof. The UL grant may be accompanied by the sidelink grant 220 (e.g., a mode 1 sidelink grant) for the meta-surface controller 210 to transmit the individual uplink grants 230 to the UEs 115-a. In some examples, the sidelink grant 220 may indicate multiple resource for serving the multiple UEs 115-a in the group.

The meta-surface controller 210 may parse the combined uplink grant 225 and may generate the individual uplink grants 230 for each of the UEs 115-a indicated in the combined uplink grant 225. Based on the combined uplink grant 225, the meta-surface controller 210 may generate an individual uplink grant 230 for each UE 115-a. An individual uplink grant 230 may include a BWP associated with the individual uplink grant 230, a resource allocation, an MCS indication, a pre-coder index for uplink transmissions, precoding information for uplink transmissions, one or more additional grant parameters, or any combination thereof. In some examples, such information included in the individual uplink grants 230 may be information determined during the training process or may be based on information determined during the training process.

The meta-surface controller 210 may configure, via the control signal 235, the meta-surface 215 in accordance with the combined uplink grant 225, the individual uplink grants 230, one or more additional parameters for wireless communications in an MA scheme, or any combination thereof. For example, the meta-surface controller 210 may be co-located with the meta-surface 215 and may be coupled to or communicate with the meta-surface 215 via a direct or indirect wired connection. The meta-surface controller 210 may configure, adapt, control, modify, or adjust one or more aspects, characteristics, or functions of the meta-surface using the wired connection (e.g., optionally by transmitting the control signal 235 via the wired connection). The control signal 235 may include indications of one or more parameters of the meta-surface 215. For example, the control signal 235 may include parameters that adjust a reflectivity, a refractivity, a channel gain, one or more additional channel parameters or characteristics of the uplink channels used by the UEs 115-a to transmit the uplink transmissions 240, or any combination thereof. For example, the meta-surface controller 210 may indicate parameters to the meta-surface 215 that cause the meta-surface 215 to reflect a transmission from a first UE 115-a and refract a transmission from a second UE 115-a (e.g., as depicted in FIG. 2).

The UEs 115-a may then transmit their respective uplink transmissions 240, using the meta-surface 215 to redirect the transmissions or alter their respective channels as configured by the meta-surface controller 210.

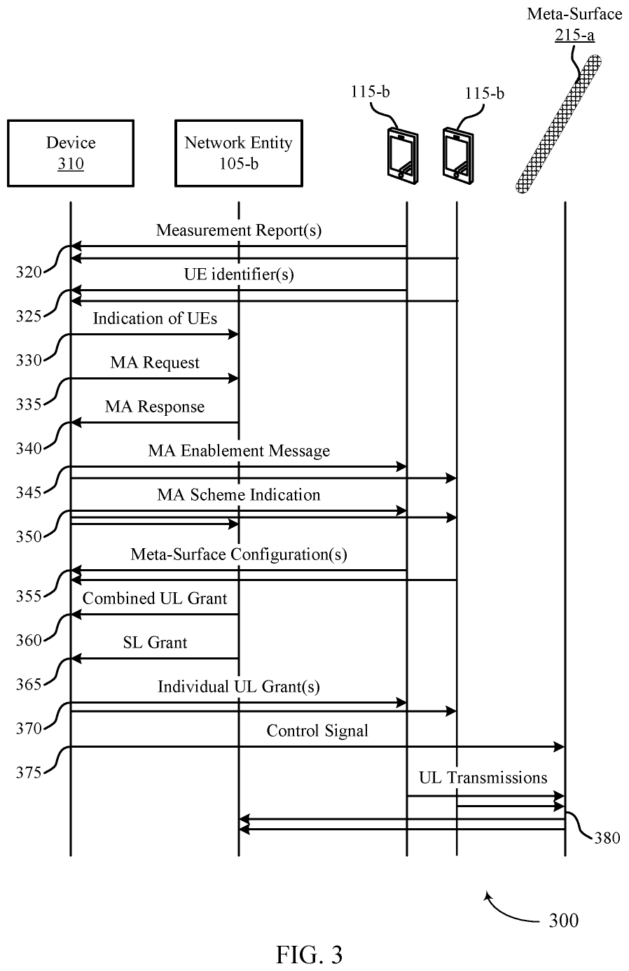

FIG. 3 illustrates an example of a process flow 300 that supports meta-surface enabled multiple access control in accordance with one or more examples as disclosed herein. The process flow 300 may implement various aspects of the present disclosure described herein. The elements described in the process flow 300 (e.g., the device 310, the network entity 105-b, the UE 115-b, and the meta-surface 215-a) may be examples of similarly-named elements described herein.

In the following description of the process flow 300, the operations between the various entities or elements may be performed in different orders or at different times. Some operations may also be left out of the process flow 300, or other operations may be added. Although the various entities or elements are shown performing the operations of the process flow 300, some aspects of some operations may also be performed by other entities or elements of the process flow 300 or by entities or elements that are not depicted in the process flow, or any combination thereof.

At 320, the device 310 may receive one or more measurement reports for one or more channels associated with the plurality of UEs 115-b and the meta-surface 215-a. In some examples, the device 310 may be a meta-surface controller.

At 325, the device 310 may receive one or more cell-specific identifiers associated with the plurality of UEs 115-b and one or more cell identifiers associated with the plurality of UEs 115-b.

At 330, the device 310 may transmit, to the network entity 105-b via the access link, an indication of the plurality of UEs 115-b associated with the meta-surface. In some examples, the indication of the plurality of UEs 115-b may include an indication of a multiple access group that includes the plurality of UEs 115-b based on the one or more measurement reports. Additionally, or alternatively, the indication of the plurality of UEs 115-b may include an indication of a multiple access group that includes the plurality of UEs 115-b based on the one or more cell-specific identifiers and the one or more cell identifiers.

At 335, the device 310 may transmit, to the network entity 105-b via the access link, a request to enable a multiple access communication scheme for the plurality of UEs 115-b via the meta-surface 215-a. In some examples, the request further may include an identifier associated with the device 310, an identifier associated with the plurality of UEs 115-b, one or more identifiers for individual UEs of the plurality of UEs 115-b, or any combination thereof. Additionally, or alternatively, the request further may include one or more channel measurement reports for one or more channels between the meta-surface 215-a and one or more UEs of the plurality of UEs 115-b.

At 340, the device 310 may receive, based on the request, a response message indicating that the multiple access communication scheme is enabled for the plurality of UEs 115-b and the individual uplink grants are transmitted based on receiving the response message.

At 345, the device 310 may transmit, to the plurality of UEs 115-b and based on the response message, an indication that meta-surface enabled multiple access for the plurality of UEs 115-b has been enabled.

At 350, the device 310 may transmit an indication of a multiple access scheme associated with the plurality of UEs 115-b.

At 355, the device 310 may receive, from the plurality of UEs 115-b, one or more meta-surface configurations for individual UEs of the plurality of UEs 115-b.

At 360, the device 310 may receive, from the network entity 105-b via the access link, a combined uplink grant for the plurality of UEs 115-b. In some examples, the combined uplink grant may include an indication of a bandwidth part associated with the combined uplink grant, an indication of a common resource allocation, an identifier associated with the plurality of UEs 115-b, a list of UEs of the plurality of UEs 115-b that are scheduled by the combined uplink grant, a list of modulation and coding scheme orders for each UE 115-b of the list of UEs being scheduled by the combined uplink grant, an indication of the sidelink grant, or any combination thereof.

At 365, the device 310 may receive, from a network entity 105-b via an access link, a sidelink grant for forwarding a combined uplink grant to a plurality of user equipments (UEs).

At 370, the device 310 may transmit, based on the combined uplink grant, individual uplink grants to the plurality of UEs 115-b in accordance with the sidelink grant. In some examples, the individual uplink grants indicate a bandwidth part for the one or more uplink transmissions, a common resource allocation for the one or more uplink transmissions, precoding information for the one or more uplink transmissions, or any combination thereof.

At 375, the device 310 may configure, via a control signal, a meta-surface 215 to redirect one or more uplink transmissions from the plurality of UEs 115-b to the network entity 105-b in accordance with the individual uplink grants. In some examples, the control signal may indicate to redirect the one or more uplink transmissions and may be based on the one or more meta-surface configurations.

At 380, the plurality of UEs 115-b may transmit uplink transmissions to the meta-surface 215-a that may alter respective channels of the uplink transmissions to redirect (e.g., reflect, refract, diffract, or otherwise alter or redirect) the uplink transmissions towards the network entity 105-b.

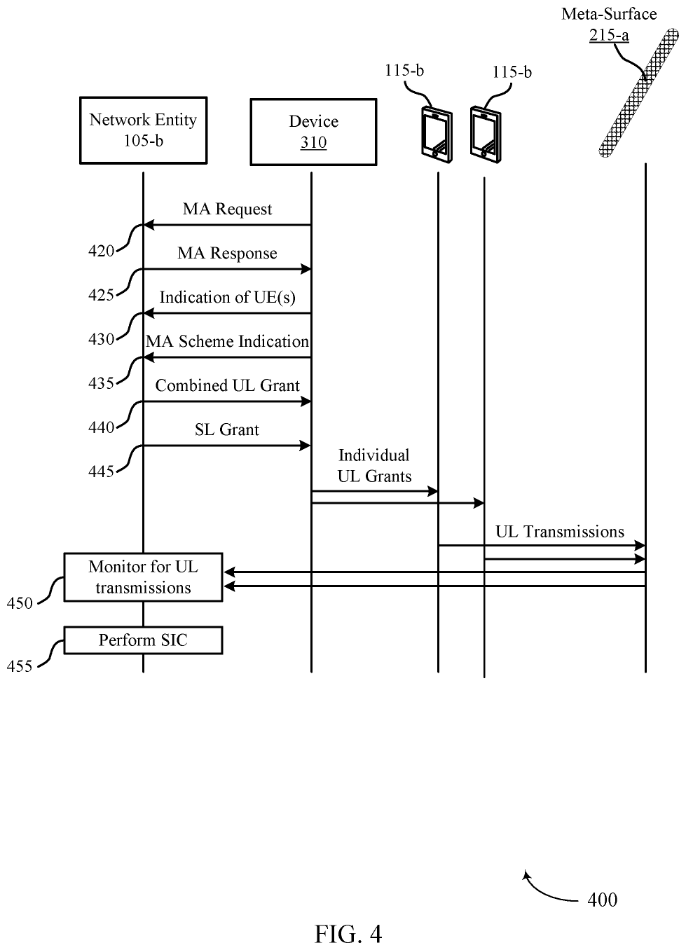

FIG. 4 illustrates an example of a process flow 400 that supports meta-surface enabled multiple access control in accordance with one or more examples as disclosed herein. The process flow 400 may implement various aspects of the present disclosure described herein. The elements described in the process flow 400 (e.g., the network entity 105-b, the device 310, the plurality of UEs 115-b, and the meta-surface 215-a) may be examples of similarly-named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the network entity 105-b may receive a request to enable meta-surface 215-a multiple access for the plurality of UEs 115-b, and the request may include the indication of the plurality of UEs 115-b. In some examples, the request further may include an identifier associated with the device 310, an identifier associated with the plurality of UEs 115-b, one or more identifiers for individual UEs of the plurality of UEs 115-b, or any combination thereof. Additionally, or alternatively, the request further may include one or more channel measurement reports for one or more channels between the meta-surface 215-a and the plurality of UEs 115-b.

At 425, the network entity 105-b may transmit, based on the indication of the plurality of UEs 115-b, a response message enabling the meta-surface 215-a multiple access for the plurality of UEs 115-b.

At 430, the network entity 105-b may receive, from a device 310 via an access link, an indication of a plurality of UEs associated with a meta-surface 215-a controlled by the device 310.

At 435, the network entity 105-b may receive an indication of a multiple access scheme associated with the plurality of UEs 115-b.

At 440, the network entity 105-b may transmit, via the access link, a combined uplink grant for the plurality of UEs 115-b. In some examples, the combined uplink grant may include an indication of a bandwidth part associated with the combined uplink grant, an indication of a common resource allocation, an identifier associated with the plurality of UEs 115-b, a list of UEs of the plurality of UEs 115-b that are scheduled by the combined uplink grant, a list of modulation and coding scheme orders for each UE of the list of UEs being scheduled by the combined uplink grant, an indication of the sidelink grant, or any combination thereof.

At 445, the network entity 105-b may transmit, to the device 310 via the access link, a sidelink grant for relay by the device 310 to the plurality of UEs 115-b. In some examples, the device 310 may forward individual UE grants to the plurality of UEs 115-b.

At 450, the network entity 105-b may monitor for one or more uplink transmissions from the plurality of UEs 115-b via the meta-surface 215-a in accordance with the combined uplink grant. In some examples, the one or more uplink transmissions comprise multiple uplink transmissions. For example, the one or more uplink transmissions may be uplink transmissions from multiple UEs 115-b that received the individual UL grants and the uplink transmissions may be transmitted in accordance with the individual UL grants.

At 455, the network entity 105-b may perform a successive interference cancelation process on the multiple uplink transmissions to decode one or more of the multiple uplink transmissions.

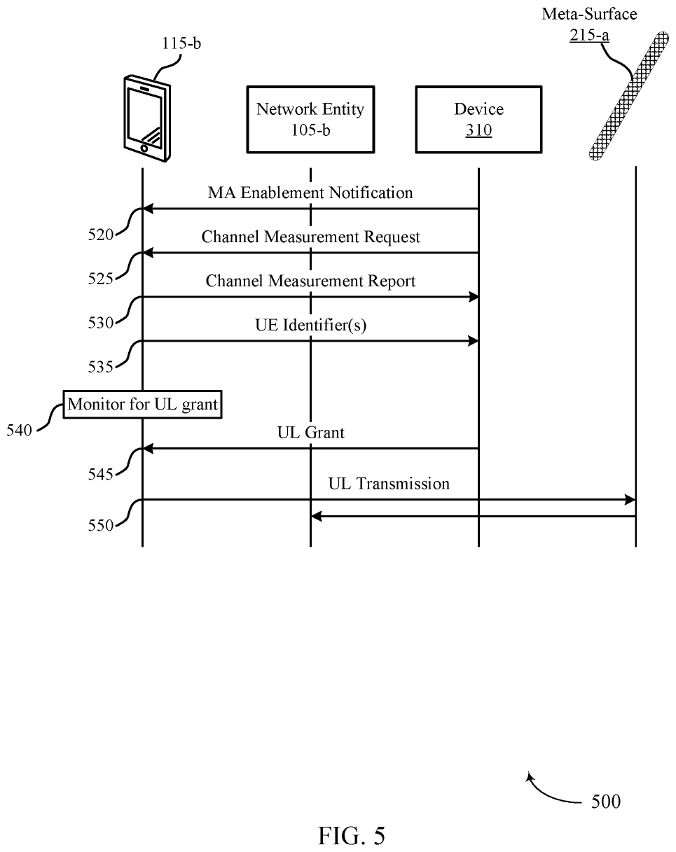

FIG. 5 illustrates an example of a process flow 500 that supports meta-surface enabled multiple access control in accordance with one or more examples as disclosed herein. The process flow 500 may implement various aspects of the present disclosure described herein. The elements described in the process flow 500 (e.g., the UE 115-b, the network entity 105-b, the device 310, and the meta-surface 215-a) may be examples of similarly-named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the UE 115-b may receive a notification that uplink multiple access communications are enabled for a plurality of UEs that may include the UE and monitoring for the uplink grant is based on receiving the notification.

At 525, the UE 115-b may receive, via a sidelink channel, a channel measurement request indicating a sidelink resource for the channel measurement.

At 530, the UE 115-b may transmit, to a device 310, a channel measurement report indicating a channel measurement of a channel between the UE and a meta-surface 215-a associated with the device 310. In some examples, the channel measurement report may indicate a requested meta-surface configuration for the meta-surface 215-a based on the channel measurement.

At 535, the UE 115-b may transmit a cell-specific identifier associated with the UE and a cell identifier associated with the UE.

At 540, the UE 115-b may monitor for an uplink grant for transmissions that are to be redirected from the UE to the network entity 105-b by the meta-surface 215-a.

At 545, the UE 115-b may receive, in accordance with a sidelink grant, the uplink grant from the device 310. In some examples, the uplink grant includes an indication of a bandwidth part associated with the uplink grant, an indication of a common resource allocation common to a plurality of UEs that may include the UE, precoding information for the uplink transmission, or any combination thereof.

At 550, the UE 115-b may transmit an uplink transmission in accordance with the uplink grant.

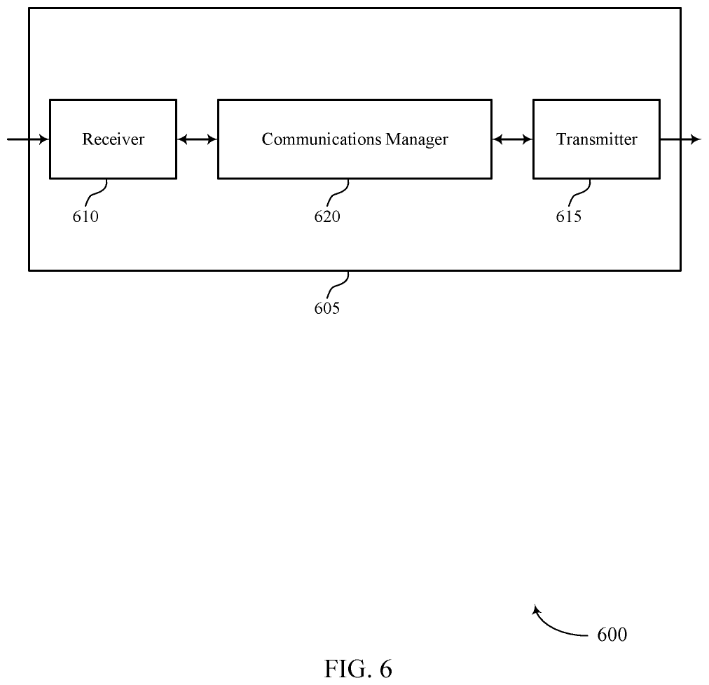

FIG. 6 illustrates a block diagram 600 of a device 605 that supports meta-surface enabled multiple access control in accordance with one or more examples as disclosed herein. The device 605 may be an example of aspects of a meta-surface controller as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (for example, control channels, data channels, information channels related to meta-surface enabled multiple access control). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (for example, control channels, data channels, information channels related to meta-surface enabled multiple access control). In some implementations, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of meta-surface enabled multiple access control as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

Additionally, or alternatively, the communications manager 620 may support wireless communication at a device in accordance with examples as disclosed herein. For example, the communications manager 620 may be configured as or otherwise support a means for receiving, from a network entity via an access link, a sidelink grant for forwarding a combined uplink grant to a set of multiple user equipments (UEs). The communications manager 620 may be configured as or otherwise support a means for transmitting, based on the combined uplink grant, individual uplink grants to the set of multiple UEs in accordance with the sidelink grant. The communications manager 620 may be configured as or otherwise support a means for configuring, via a control signal, a meta-surface to redirect one or more uplink transmissions from the set of multiple UEs to the network entity in accordance with the individual uplink grants.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, more efficient utilization of communication resources, or any combination thereof.

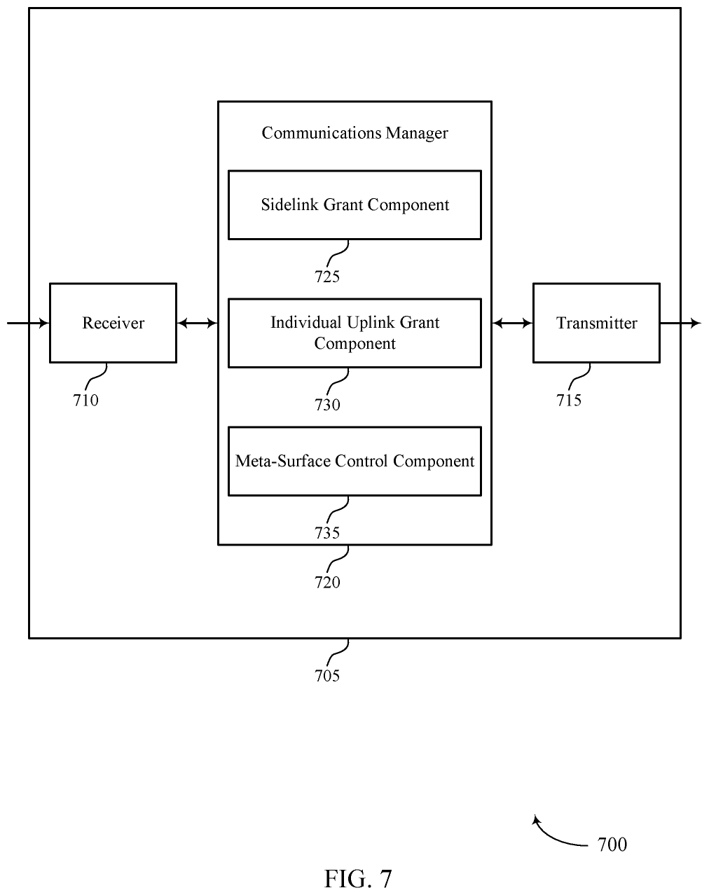

FIG. 7 illustrates a block diagram 700 of a device 705 that supports meta-surface enabled multiple access control in accordance with one or more examples as disclosed herein. The device 705 may be an example of aspects of a device 605 or a meta-surface controller 210 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (for example, control channels, data channels, information channels related to meta-surface enabled multiple access control). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (for example, control channels, data channels, information channels related to meta-surface enabled multiple access control). In some implementations, the transmitter 715 may be co-located with a receiver 710 in a transceiver module. The transmitter 715 may utilize a single antenna or a set of multiple antennas.

The device 705, or various components thereof, may be an example of means for performing various aspects of meta-surface enabled multiple access control as described herein. For example, the communications manager 720 may include a sidelink grant component 725, an individual uplink grant component 730, a meta-surface control component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a device in accordance with examples as disclosed herein. The sidelink grant component 725 may be configured as or otherwise support a means for receiving, from a network entity via an access link, a sidelink grant for forwarding a combined uplink grant to a set of multiple user equipments (UEs). The individual uplink grant component 730 may be configured as or otherwise support a means for transmitting, based on the combined uplink grant, individual uplink grants to the set of multiple UEs in accordance with the sidelink grant. The meta-surface control component 735 may be configured as or otherwise support a means for configuring, via a control signal, a meta-surface to redirect one or more uplink transmissions from the set of multiple UEs to the network entity in accordance with the individual uplink grants.

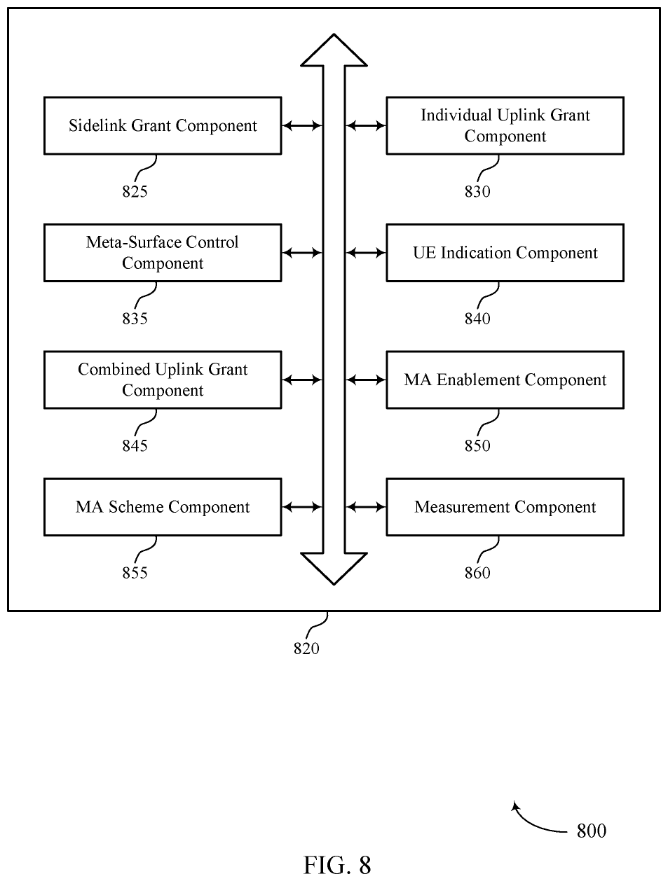

FIG. 8 illustrates a block diagram 800 of a communications manager 820 that supports meta-surface enabled multiple access control in accordance with one or more examples as disclosed herein. The communications manager 820 may be an example of aspects of a communications manager 620, a communications manager 720, or both, as described herein. The communications manager 820, or various components thereof, may be an example of means for performing various aspects of meta-surface enabled multiple access control as described herein. For example, the communications manager 820 may include a sidelink grant component 825, an individual uplink grant component 830, a meta-surface control component 835, a UE indication component 840, a combined uplink grant component 845, a MA enablement component 850, a MA scheme component 855, a measurement component 860, or any combination thereof. Each of these components may communicate, directly or indirectly, with one another (e.g., via one or more buses).

Additionally, or alternatively, the communications manager 820 may support wireless communication at a device in accordance with examples as disclosed herein. The sidelink grant component 825 may be configured as or otherwise support a means for receiving, from a network entity via an access link, a sidelink grant for forwarding a combined uplink grant to a set of multiple user equipments (UEs). The individual uplink grant component 830 may be configured as or otherwise support a means for transmitting, based on the combined uplink grant, individual uplink grants to the set of multiple UEs in accordance with the sidelink grant. The meta-surface control component 835 may be configured as or otherwise support a means for configuring, via a control signal, a meta-surface to redirect one or more uplink transmissions from the set of multiple UEs to the network entity in accordance with the individual uplink grants.

In some examples, the UE indication component 840 may be configured as or otherwise support a means for transmitting, to the network entity via the access link, an indication of the set of multiple UEs associated with the meta-surface. In some examples, the combined uplink grant component 845 may be configured as or otherwise support a means for receiving, from the network entity via the access link, a combined uplink grant for the set of multiple UEs.

In some examples, the MA enablement component 850 may be configured as or otherwise support a means for transmitting, to the network entity via the access link, a request to enable a multiple access communication scheme for the set of multiple UEs via the meta-surface. In some examples, the MA enablement component 850 may be configured as or otherwise support a means for receiving, based on the request, a response message indicating that the multiple access communication scheme is enabled for the set of multiple UEs, where transmitting the individual uplink grants is based on receiving the response message.

In some examples, the request further includes an identifier associated with the device, an identifier associated with the set of multiple UEs, one or more identifiers for individual UEs of the set of multiple UEs, or any combination thereof.

In some examples, the request further includes one or more channel measurement reports for one or more channels between the meta-surface and one or more UEs of the set of multiple UEs.

In some examples, the MA enablement component 850 may be configured as or otherwise support a means for transmitting, to the set of multiple UEs and based on the response message, an indication that meta-surface enabled multiple access for the set of multiple UEs has been enabled.

In some examples, the MA scheme component 855 may be configured as or otherwise support a means for transmitting an indication of a multiple access scheme associated with the set of multiple UEs.

In some examples, the combined uplink grant includes an indication of a bandwidth part associated with the combined uplink grant, an indication of a common resource allocation, an identifier associated with the set of multiple UEs, a list of UEs of the set of multiple UEs that are scheduled by the combined uplink grant, a list of modulation and coding scheme orders for each UE of the list of UEs being scheduled by the combined uplink grant, an indication of the sidelink grant, or any combination thereof.

In some examples, the individual uplink grants indicate a bandwidth part for the one or more uplink transmissions, a common resource allocation for the one or more uplink transmissions, precoding information for the one or more uplink transmissions, or any combination thereof.

In some examples, the measurement component 860 may be configured as or otherwise support a means for receiving one or more measurement reports for one or more channels associated with the set of multiple UEs and the meta-surface. In some examples, the UE indication component 840 may be configured as or otherwise support a means for transmitting, to the network entity via the access link, an indication of the set of multiple UEs associated with the meta-surface, where the indication of the set of multiple UEs includes an indication of a multiple access group that includes the set of multiple UEs based on the one or more measurement reports.

In some examples, the UE indication component 840 may be configured as or otherwise support a means for transmitting, to the network entity via the access link, an indication of the set of multiple UEs associated with the meta-surface. In some examples, the UE indication component 840 may be configured as or otherwise support a means for receiving one or more cell-specific identifiers associated with the set of multiple UEs and one or more cell identifiers associated with the set of multiple UEs, where the indication of the set of multiple UEs includes an indication of a multiple access group that includes the set of multiple UEs based on the one or more cell-specific identifiers and the one or more cell identifiers.

In some examples, the meta-surface control component 835 may be configured as or otherwise support a means for receiving, from the set of multiple UEs, one or more meta-surface configurations for individual UEs of the set of multiple UEs. In some examples, the meta-surface control component 835 may be configured as or otherwise support a means for configuring, via the control signal, the meta-surface to redirect the one or more uplink transmissions is based on the one or more meta-surface configurations.

In some examples, the device is a meta-surface controller.

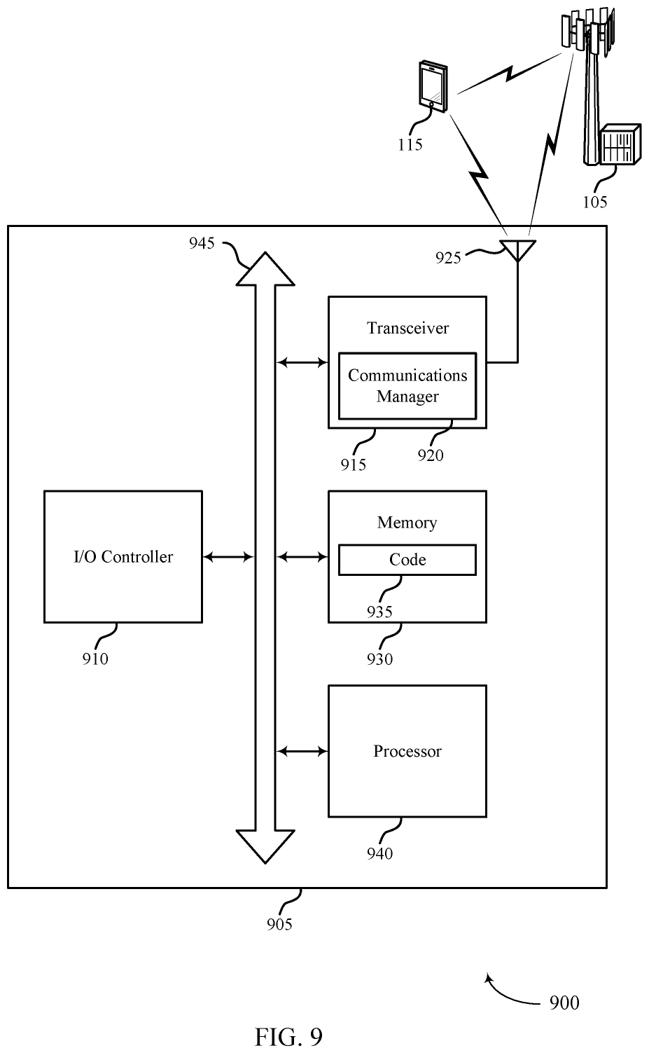

FIG. 9 illustrates a diagram of a system 900 including a device 905 that supports meta-surface enabled multiple access control in accordance with one or more examples as disclosed herein. The device 905 may be an example of or include the components of a device 605, a device 705, or a meta-surface controller as described herein. The device 905 may include components for bi-directional voice and data communications including components for transmitting and receiving communications, such as a communications manager 920, an I/O controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 also may manage peripherals not integrated into the device 905. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some implementations, the I/O controller 910 may be implemented as part of a processor or processing system, such as the processor 940. In some implementations, a user may interact with the device 905 via the I/O controller 910 or via hardware components controlled by the I/O controller 910.

In some implementations, the device 905 may include a single antenna 925. However, in some other implementations, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 also may include a modem to modulate the packets, to provide the modulated packets to one or more antennas 925 for transmission, and to demodulate packets received from the one or more antennas 925. In some implementations, the transceiver 915 may include one or more interfaces, such as one or more interfaces coupled with the one or more antennas 925 that are configured to support various receiving or obtaining operations, or one or more interfaces coupled with the one or more antennas 925 that are configured to support various transmitting or outputting operations, or a combination thereof. In some implementations, the transceiver 915 may include or be configured for coupling with one or more processors or memory components that are operable to perform or support operations based on received or obtained information or signals, or to generate information or other signals for transmission or other outputting, or any combination thereof. In some implementations, the transceiver 915, or the transceiver 915 and the one or more antennas 925, or the transceiver 915 and the one or more antennas 925 and one or more processors or memory components (for example, the processor 940, or the memory 930, or both), may be included in a chip or chip assembly that is installed in the device 905.

The memory 930 may include RAM and ROM. The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some implementations, the code 935 may not be directly executable by the processor 940 but may cause a computer (for example, when compiled and executed) to perform functions described herein. In some implementations, the memory 930 may contain, among other things, a BIOS which may control basic hardware or software operation such as the interaction with peripheral components or devices.

The processor 940 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting meta-surface enabled multiple access control). For example, the device 905 or a component of the device 905 may include a processor 940 and memory 930 coupled with the processor 940, the processor 940 and memory 930 configured to perform various functions described herein. The processor 940 may be an example of a cloud-computing platform (e.g., one or more physical nodes and supporting software such as operating systems, virtual machines, or container instances) that may host the functions (e.g., by executing code 935) to perform the functions of the device 905. The processor 940 may be any one or more suitable processors capable of executing scripts or instructions of one or more software programs stored in the device 905 (such as within the memory 930). In some implementations, the processor 940 may be a component of a processing system. A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the processor 940, or the transceiver 915, or the communications manager 920, or other components or combinations of components of the device 905. The processing system of the device 905 may interface with other components of the device 905, and may process information received from other components (such as inputs or signals) or output information to other components. For example, a chip or modem of the device 905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 905 may transmit information output from the chip or modem. Additionally, or alternatively, in some implementations, the one or more interfaces may refer to an interface between the processing system of the chip or modem and a receiver, such that the device 905 may obtain information or signal inputs, and the information may be passed to the processing system. A person having ordinary skill in the art will readily recognize that a first interface also may obtain information or signal inputs, and a second interface also may output information or signal outputs.

Additionally, or alternatively, the communications manager 920 may support wireless communication at a device in accordance with examples as disclosed herein. For example, the communications manager 920 may be configured as or otherwise support a means for receiving, from a network entity via an access link, a sidelink grant for forwarding a combined uplink grant to a set of multiple user equipments (UEs). The communications manager 920 may be configured as or otherwise support a means for transmitting, based on the combined uplink grant, individual uplink grants to the set of multiple UEs in accordance with the sidelink grant. The communications manager 920 may be configured as or otherwise support a means for configuring, via a control signal, a meta-surface to redirect one or more uplink transmissions from the set of multiple UEs to the network entity in accordance with the individual uplink grants.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some implementations, the communications manager 920 may be configured to perform various operations (for example, receiving, monitoring, transmitting) using or otherwise in cooperation with the transceiver 915, the one or more antennas 925, or any combination thereof. Although the communications manager 920 is illustrated as a component of the transceiver 915, in some implementations, one or more functions described with reference to the communications manager 920 may be supported by or performed by the transceiver 915, the processor 940, the memory 930, the code 935, or any combination thereof. For example, the code 935 may include instructions executable by the processor 940 to cause the device 905 to perform various aspects of meta-surface enabled multiple access control as described herein, or the processor 940 and the memory 930 may be otherwise configured to perform or support such operations.

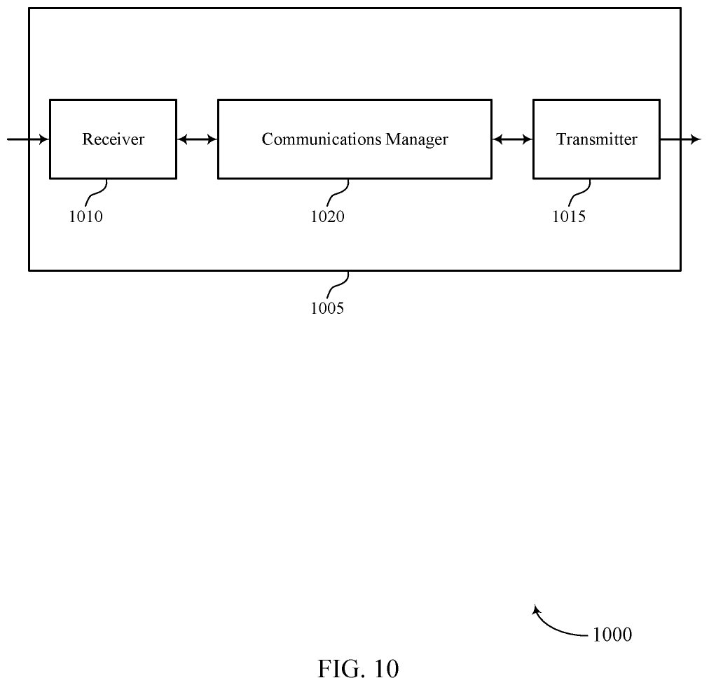

FIG. 10 illustrates a block diagram 1000 of a device 1005 that supports meta-surface enabled multiple access control in accordance with one or more examples as disclosed herein. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of meta-surface enabled multiple access control as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

Additionally, or alternatively, the communications manager 1020 may support wireless communications at a network entity in accordance with examples as disclosed herein. For example, the communications manager 1020 may be configured as or otherwise support a means for receiving, from a device via an access link, an indication of a set of multiple user equipments (UEs) associated with a meta-surface controlled by the device. The communications manager 1020 may be configured as or otherwise support a means for transmitting, via the access link, a combined uplink grant for the set of multiple UEs. The communications manager 1020 may be configured as or otherwise support a means for transmitting, to the device via the access link, a sidelink grant for relay by the device to the set of multiple UEs. The communications manager 1020 may be configured as or otherwise support a means for monitoring for one or more uplink transmissions from the set of multiple UEs via the meta-surface in accordance with the combined uplink grant.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, more efficient utilization of communication resources, or any combination thereof.

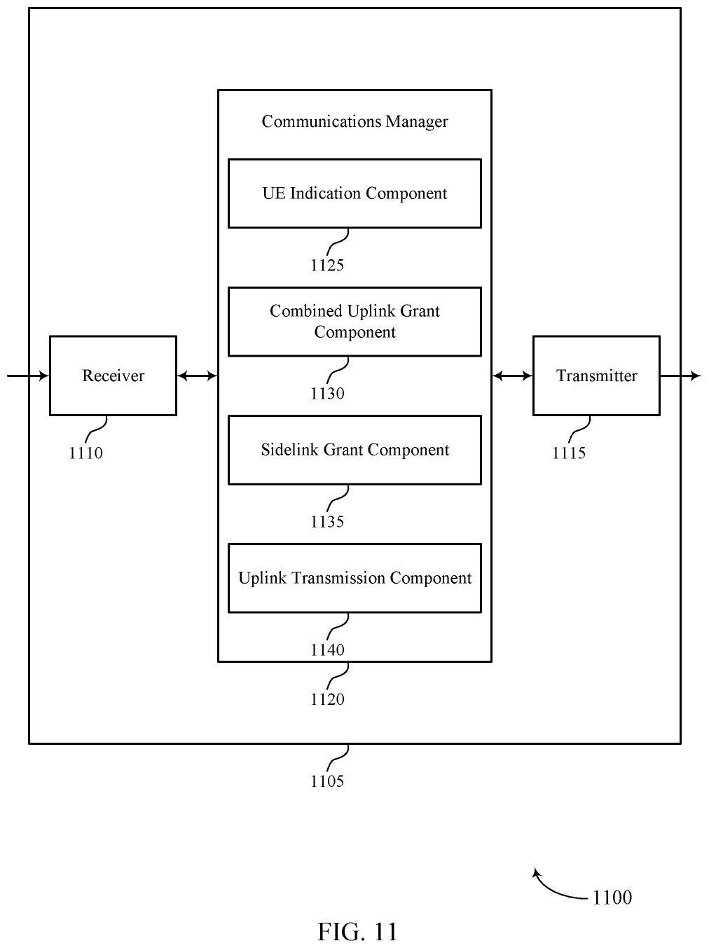

FIG. 11 illustrates a block diagram 1100 of a device 1105 that supports meta-surface enabled multiple access control in accordance with one or more examples as disclosed herein. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of meta-surface enabled multiple access control as described herein. For example, the communications manager 1120 may include a UE indication component 1125, a combined uplink grant component 1130, a sidelink grant component 1135, an uplink transmission component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The UE indication component 1125 may be configured as or otherwise support a means for receiving, from a device via an access link, an indication of a set of multiple user equipments (UEs) associated with a meta-surface controlled by the device. The combined uplink grant component 1130 may be configured as or otherwise support a means for transmitting, via the access link, a combined uplink grant for the set of multiple UEs. The sidelink grant component 1135 may be configured as or otherwise support a means for transmitting, to the device via the access link, a sidelink grant for relay by the device to the set of multiple UEs. The uplink transmission component 1140 may be configured as or otherwise support a means for monitoring for one or more uplink transmissions from the set of multiple UEs via the meta-surface in accordance with the combined uplink grant.

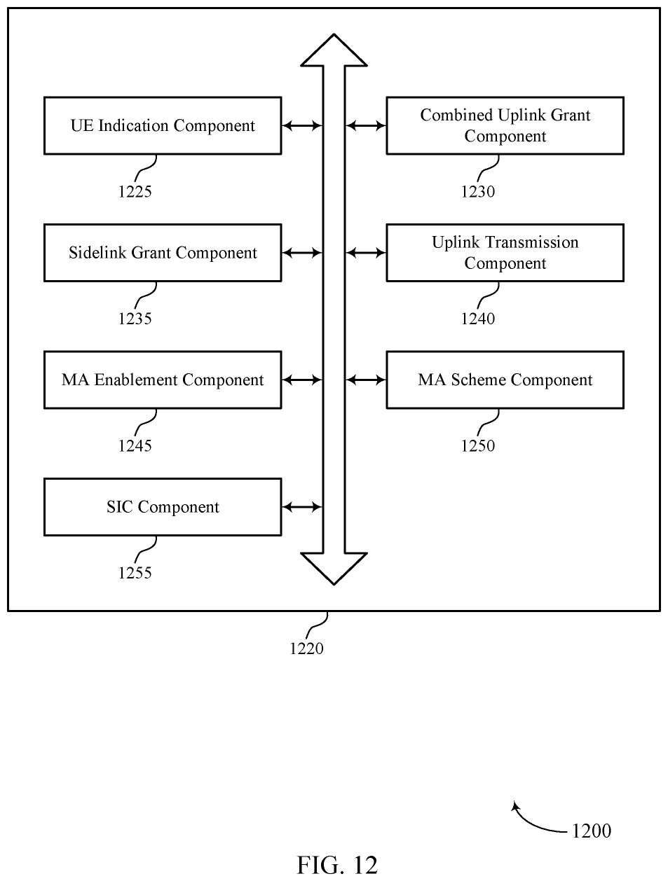

FIG. 12 illustrates a block diagram 1200 of a communications manager 1220 that supports meta-surface enabled multiple access control in accordance with one or more examples as disclosed herein. The communications manager 1220 may be an example of aspects of a communications manager 1020, a communications manager 1120, or both, as described herein. The communications manager 1220, or various components thereof, may be an example of means for performing various aspects of meta-surface enabled multiple access control as described herein. For example, the communications manager 1220 may include a UE indication component 1225, a combined uplink grant component 1230, a sidelink grant component 1235, an uplink transmission component 1240, a MA enablement component 1245, a MA scheme component 1250, an SIC component 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1220 may support wireless communications at a network entity in accordance with examples as disclosed herein. The UE indication component 1225 may be configured as or otherwise support a means for receiving, from a device via an access link, an indication of a set of multiple user equipments (UEs) associated with a meta-surface controlled by the device. The combined uplink grant component 1230 may be configured as or otherwise support a means for transmitting, via the access link, a combined uplink grant for the set of multiple UEs. The sidelink grant component 1235 may be configured as or otherwise support a means for transmitting, to the device via the access link, a sidelink grant for relay by the device to the set of multiple UEs. The uplink transmission component 1240 may be configured as or otherwise support a means for monitoring for one or more uplink transmissions from the set of multiple UEs via the meta-surface in accordance with the combined uplink grant.

In some examples, the MA enablement component 1245 may be configured as or otherwise support a means for receiving a request to enable meta-surface enabled multiple access for the set of multiple UEs, the request including the indication of the set of multiple UEs. In some examples, the MA enablement component 1245 may be configured as or otherwise support a means for transmitting, based on the indication of the set of multiple UEs, a response message enabling the meta-surface enabled multiple access for the set of multiple UEs.

In some examples, the request further includes an identifier associated with the device, an identifier associated with the set of multiple UEs, one or more identifiers for individual UEs of the set of multiple UEs, or any combination thereof.

In some examples, the request further includes one or more channel measurement reports for one or more channels between the meta-surface and the set of multiple UEs.

In some examples, the MA scheme component 1250 may be configured as or otherwise support a means for receiving an indication of a multiple access scheme associated with the set of multiple UEs.

In some examples, the combined uplink grant includes an indication of a bandwidth part associated with the combined uplink grant, an indication of a common resource allocation, an identifier associated with the set of multiple UEs, a list of UEs of the set of multiple UEs that are scheduled by the combined uplink grant, a list of modulation and coding scheme orders for each UE of the list of UEs being scheduled by the combined uplink grant, an indication of the sidelink grant, or any combination thereof.

In some examples, the one or more uplink transmissions include multiple uplink transmissions, and the SIC component 1255 may be configured as or otherwise support a means for performing a successive interference cancelation process on the multiple uplink transmissions to decode one or more of the multiple uplink transmissions.

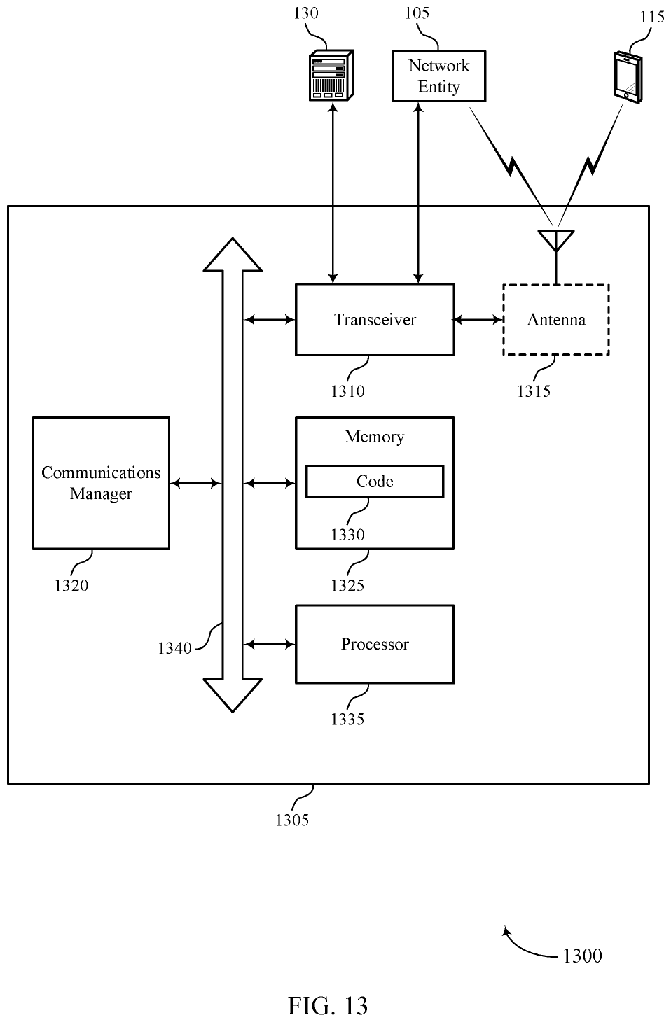

FIG. 13 illustrates a diagram of a system 1300 including a device 1305 that supports meta-surface enabled multiple access control in accordance with one or more examples as disclosed herein. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting meta-surface enabled multiple access control). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

Additionally, or alternatively, the communications manager 1320 may support wireless communications at a network entity in accordance with examples as disclosed herein. For example, the communications manager 1320 may be configured as or otherwise support a means for receiving, from a device via an access link, an indication of a set of multiple user equipments (UEs) associated with a meta-surface controlled by the device. The communications manager 1320 may be configured as or otherwise support a means for transmitting, via the access link, a combined uplink grant for the set of multiple UEs. The communications manager 1320 may be configured as or otherwise support a means for transmitting, to the device via the access link, a sidelink grant for relay by the device to the set of multiple UEs. The communications manager 1320 may be configured as or otherwise support a means for monitoring for one or more uplink transmissions from the set of multiple UEs via the meta-surface in accordance with the combined uplink grant.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of meta-surface enabled multiple access control as described herein, or the processor 1335 and the memory 1325 may be otherwise configured to perform or support such operations.

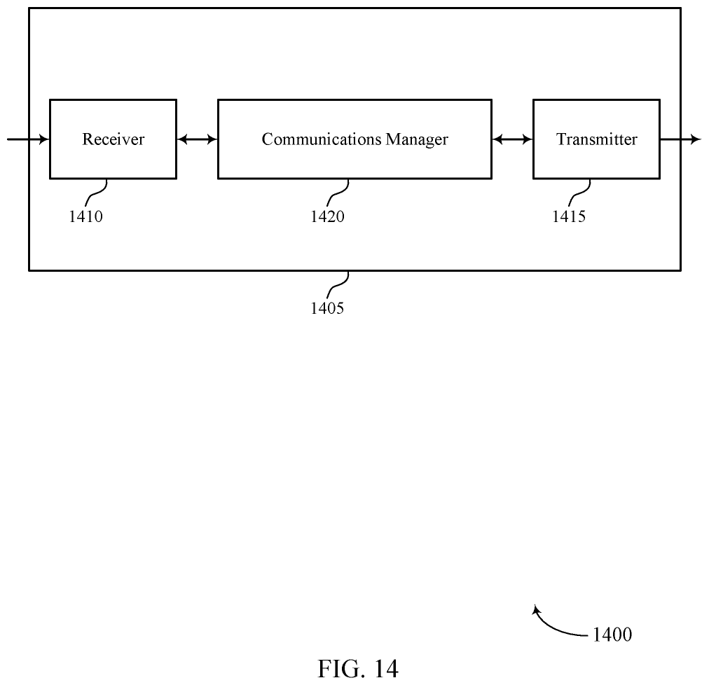

FIG. 14 illustrates a block diagram 1400 of a device 1405 that supports meta-surface enabled multiple access control in accordance with one or more examples as disclosed herein. The device 1405 may be an example of aspects of a UE 115 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to meta-surface enabled multiple access control). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to meta-surface enabled multiple access control). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations thereof or various components thereof may be examples of means for performing various aspects of meta-surface enabled multiple access control as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

Additionally, or alternatively, the communications manager 1420 may support wireless communication at a UE in accordance with examples as disclosed herein. For example, the communications manager 1420 may be configured as or otherwise support a means for transmitting, to a device, a channel measurement report indicating a channel measurement of a channel between the UE and a meta-surface associated with the device. The communications manager 1420 may be configured as or otherwise support a means for monitoring for an uplink grant for transmissions that are to be redirected from the UE to a network entity by the meta-surface. The communications manager 1420 may be configured as or otherwise support a means for transmitting an uplink transmission in accordance with the uplink grant.

By including or configuring the communications manager 1420 in accordance with examples as described herein, the device 1405 (e.g., a processor controlling or otherwise coupled with the receiver 1410, the transmitter 1415, the communications manager 1420, or a combination thereof) may support techniques for reduced processing, reduced power consumption, more efficient utilization of communication resources, or any combination thereof.

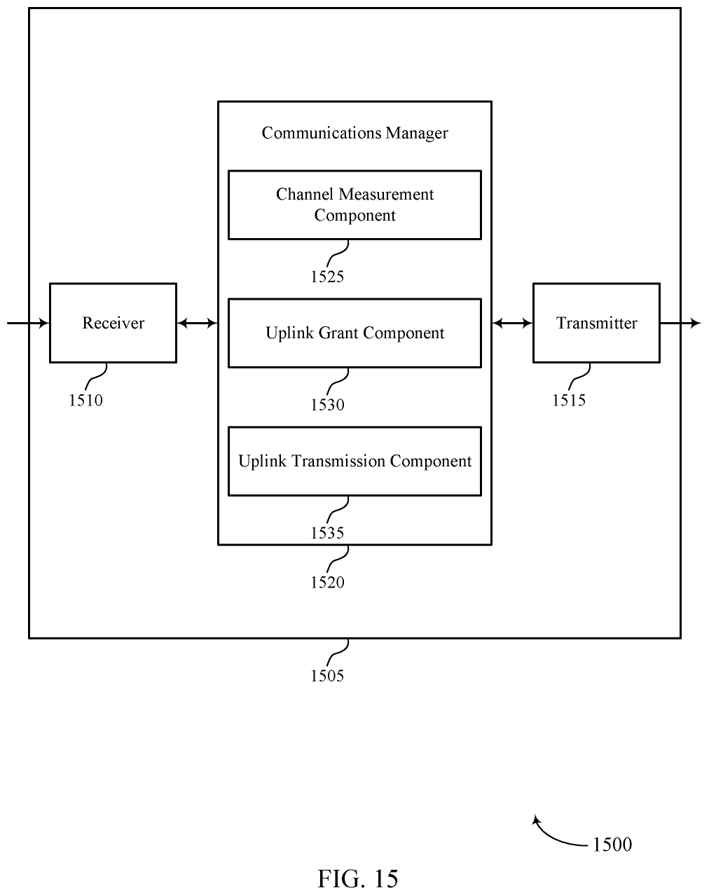

FIG. 15 illustrates a block diagram 1500 of a device 1505 that supports meta-surface enabled multiple access control in accordance with one or more examples as disclosed herein. The device 1505 may be an example of aspects of a device 1405 or a UE 115 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to meta-surface enabled multiple access control). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to meta-surface enabled multiple access control). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of meta-surface enabled multiple access control as described herein. For example, the communications manager 1520 may include a channel measurement component 1525, an uplink grant component 1530, an uplink transmission component 1535, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication at a UE in accordance with examples as disclosed herein. The channel measurement component 1525 may be configured as or otherwise support a means for transmitting, to a device, a channel measurement report indicating a channel measurement of a channel between the UE and a meta-surface associated with the device. The uplink grant component 1530 may be configured as or otherwise support a means for monitoring for an uplink grant for transmissions that are to be redirected from the UE to a network entity by the meta-surface. The uplink transmission component 1535 may be configured as or otherwise support a means for transmitting an uplink transmission in accordance with the uplink grant.

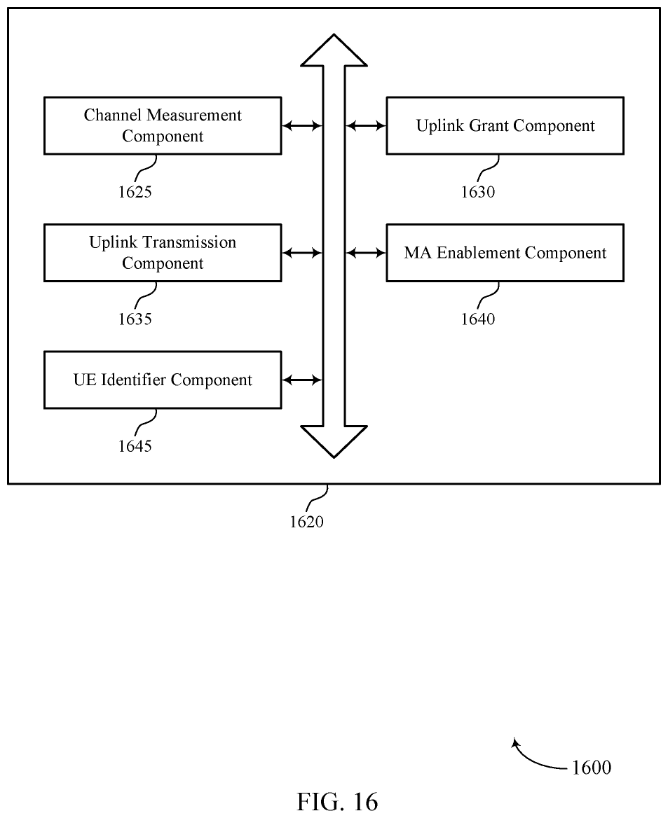

FIG. 16 illustrates a block diagram 1600 of a communications manager 1620 that supports meta-surface enabled multiple access control in accordance with one or more examples as disclosed herein. The communications manager 1620 may be an example of aspects of a communications manager 1420, a communications manager 1520, or both, as described herein. The communications manager 1620, or various components thereof, may be an example of means for performing various aspects of meta-surface enabled multiple access control as described herein. For example, the communications manager 1620 may include a channel measurement component 1625, an uplink grant component 1630, an uplink transmission component 1635, a MA enablement component 1640, a UE identifier component 1645, or any combination thereof. Each of these components may communicate, directly or indirectly, with one another (e.g., via one or more buses).

Additionally, or alternatively, the communications manager 1620 may support wireless communication at a UE in accordance with examples as disclosed herein. The channel measurement component 1625 may be configured as or otherwise support a means for transmitting, to a device, a channel measurement report indicating a channel measurement of a channel between the UE and a meta-surface associated with the device. The uplink grant component 1630 may be configured as or otherwise support a means for monitoring for an uplink grant for transmissions that are to be redirected from the UE to a network entity by the meta-surface. The uplink transmission component 1635 may be configured as or otherwise support a means for transmitting an uplink transmission in accordance with the uplink grant.

In some examples, the MA enablement component 1640 may be configured as or otherwise support a means for receiving a notification that uplink multiple access communications are enabled for a set of multiple UEs that includes the UE, where monitoring for the uplink grant is based on receiving the notification.

In some examples, the channel measurement component 1625 may be configured as or otherwise support a means for receiving, via a sidelink channel, a channel measurement request indicating a sidelink resource for the channel measurement.

In some examples, the channel measurement report indicates a requested meta-surface configuration for the meta-surface based on the channel measurement.

In some examples, the uplink grant component 1630 may be configured as or otherwise support a means for receiving, in accordance with a sidelink grant, the uplink grant from the device.

In some examples, the uplink grant includes an indication of a bandwidth part associated with the uplink grant, an indication of a common resource allocation common to a set of multiple UEs that includes the UE, precoding information for the uplink transmission, or any combination thereof.

In some examples, the UE identifier component 1645 may be configured as or otherwise support a means for transmitting a cell-specific identifier associated with the UE and a cell identifier associated with the UE.

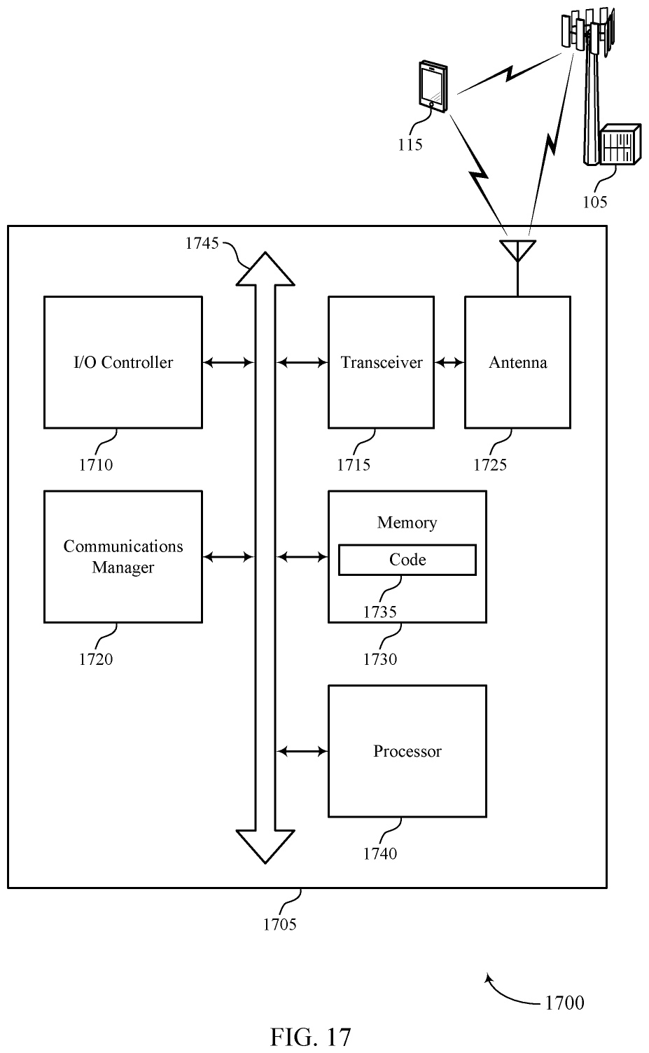

FIG. 17 illustrates a diagram of a system 1700 including a device 1705 that supports meta-surface enabled multiple access control in accordance with one or more examples as disclosed herein. The device 1705 may be an example of or include the components of a device 1405, a device 1505, or a UE 115 as described herein. The device 1705 may communicate (e.g., wirelessly) with one or more network entities 105, one or more UEs 115, or any combination thereof. The device 1705 may include components for bi-directional voice and data communications including components for transmitting and receiving communications, such as a communications manager 1720, an input/output (I/O) controller 1710, a transceiver 1715, an antenna 1725, a memory 1730, code 1735, and a processor 1740. These components may be in electronic communication or otherwise coupled (e.g., operatively, communicatively, functionally, electronically, electrically) via one or more buses (e.g., a bus 1745).

The I/O controller 1710 may manage input and output signals for the device 1705. The I/O controller 1710 may also manage peripherals not integrated into the device 1705. In some cases, the I/O controller 1710 may represent a physical connection or port to an external peripheral. In some cases, the I/O controller 1710 may utilize an operating system such as iOS®, ANDROID®, MS-DOS®, MS-WINDOWS®, OS/2®, UNIX®, LINUX®, or another known operating system. Additionally, or alternatively, the I/O controller 1710 may represent or interact with a modem, a keyboard, a mouse, a touchscreen, or a similar device. In some cases, the I/O controller 1710 may be implemented as part of a processor, such as the processor 1740. In some cases, a user may interact with the device 1705 via the I/O controller 1710 or via hardware components controlled by the I/O controller 1710.

In some cases, the device 1705 may include a single antenna 1725. However, in some other cases, the device 1705 may have more than one antenna 1725, which may be capable of concurrently transmitting or receiving multiple wireless transmissions. The transceiver 1715 may communicate bi-directionally, via the one or more antennas 1725, wired, or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described herein.

The memory 1730 may include random access memory (RAM) and read-only memory (ROM). The memory 1730 may store computer-readable, computer-executable code 1735 including instructions that, when executed by the processor 1740, cause the device 1705 to perform various functions described herein. The code 1735 may be stored in a non-transitory computer-readable medium such as system memory or another type of memory. In some cases, the code 1735 may not be directly executable by the processor 1740 but may cause a computer (e.g., when compiled and executed) to perform functions described herein. In some cases, the memory 1730 may contain, among other things, a basic I/O system (BIOS) which may control basic hardware or software operation such as the interaction with peripheral components or devices.

The processor 1740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some other cases, a memory controller may be integrated into the processor 1740. The processor 1740 may be configured to execute computer-readable instructions stored in a memory (e.g., the memory 1730) to cause the device 1705 to perform various functions (e.g., functions or tasks supporting meta-surface enabled multiple access control). For example, the device 1705 or a component of the device 1705 may include a processor 1740 and memory 1730 coupled with or to the processor 1740, the processor 1740 and memory 1730 configured to perform various functions described herein.

Additionally, or alternatively, the communications manager 1720 may support wireless communication at a UE in accordance with examples as disclosed herein. For example, the communications manager 1720 may be configured as or otherwise support a means for transmitting, to a device, a channel measurement report indicating a channel measurement of a channel between the UE and a meta-surface associated with the device. The communications manager 1720 may be configured as or otherwise support a means for monitoring for an uplink grant for transmissions that are to be redirected from the UE to a network entity by the meta-surface. The communications manager 1720 may be configured as or otherwise support a means for transmitting an uplink transmission in accordance with the uplink grant.

By including or configuring the communications manager 1720 in accordance with examples as described herein, the device 1705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the processor 1740, the memory 1730, the code 1735, or any combination thereof. For example, the code 1735 may include instructions executable by the processor 1740 to cause the device 1705 to perform various aspects of meta-surface enabled multiple access control as described herein, or the processor 1740 and the memory 1730 may be otherwise configured to perform or support such operations.

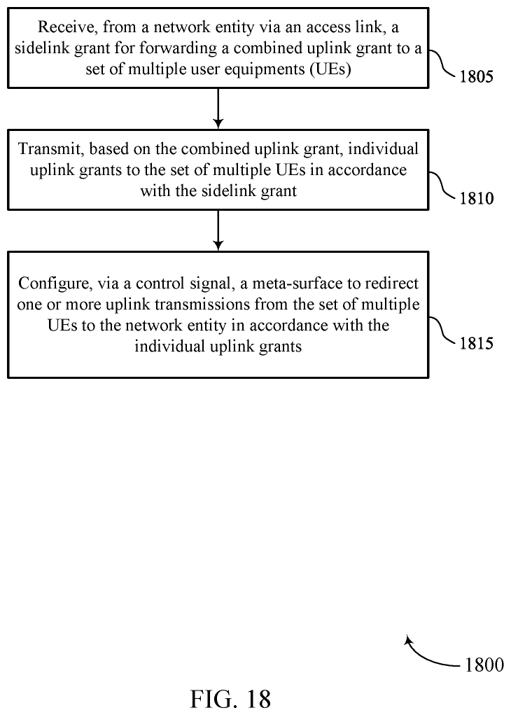

FIG. 18 illustrates a flowchart illustrating a method 1800 that supports meta-surface enabled multiple access control in accordance with one or more examples as disclosed herein. The operations of the method 1800 may be implemented by a meta-surface controller or its components as described herein. For example, the operations of the method 1800 may be performed by a meta-surface controller as described with reference to FIGS. 1 through 9. In some examples, a meta-surface controller may execute a set of instructions to control the functional elements of the meta-surface controller to perform the described functions. Additionally, or alternatively, the meta-surface controller may perform aspects of the described functions using special-purpose hardware.

At 1805, the method may include receiving, from a network entity via an access link, a sidelink grant for forwarding a combined uplink grant to a set of multiple user equipments (UEs). The operations of 1805 may be performed in accordance with examples as disclosed herein. In some examples, aspects of the operations of 1805 may be performed by a sidelink grant component 825 as described with reference to FIG. 8.

At 1810, the method may include transmitting, based on the combined uplink grant, individual uplink grants to the set of multiple UEs in accordance with the sidelink grant. The operations of 1810 may be performed in accordance with examples as disclosed herein. In some examples, aspects of the operations of 1810 may be performed by an individual uplink grant component 830 as described with reference to FIG. 8.

At 1815, the method may include configuring, via a control signal, a meta-surface to redirect one or more uplink transmissions from the set of multiple UEs to the network entity in accordance with the individual uplink grants. The operations of 1815 may be performed in accordance with examples as disclosed herein. In some examples, aspects of the operations of 1815 may be performed by a meta-surface control component 835 as described with reference to FIG. 8.

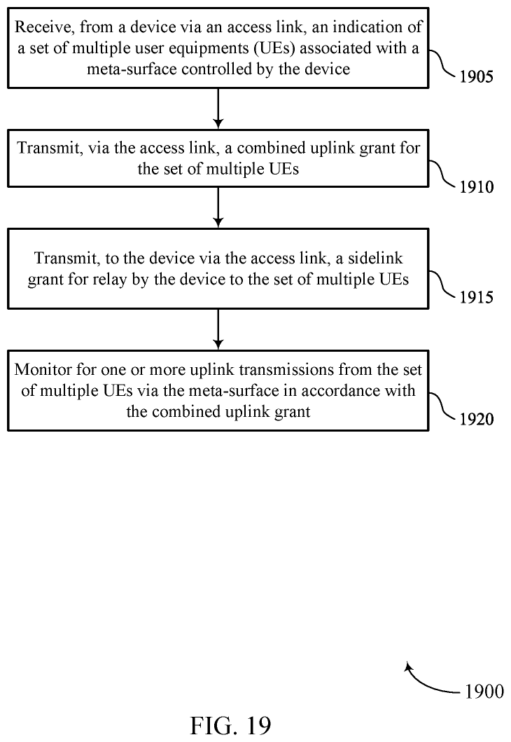

FIG. 19 illustrates a flowchart illustrating a method 1900 that supports meta-surface enabled multiple access control in accordance with one or more examples as disclosed herein. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include receiving, from a device via an access link, an indication of a set of multiple user equipments (UEs) associated with a meta-surface controlled by the device. The operations of 1905 may be performed in accordance with examples as disclosed herein. In some examples, aspects of the operations of 1905 may be performed by a UE indication component 1225 as described with reference to FIG. 12.

At 1910, the method may include transmitting, via the access link, a combined uplink grant for the set of multiple UEs. The operations of 1910 may be performed in accordance with examples as disclosed herein. In some examples, aspects of the operations of 1910 may be performed by a combined uplink grant component 1230 as described with reference to FIG. 12.

At 1915, the method may include transmitting, to the device via the access link, a sidelink grant for relay by the device to the set of multiple UEs. The operations of 1915 may be performed in accordance with examples as disclosed herein. In some examples, aspects of the operations of 1915 may be performed by a sidelink grant component 1235 as described with reference to FIG. 12.

At 1920, the method may include monitoring for one or more uplink transmissions from the set of multiple UEs via the meta-surface in accordance with the combined uplink grant. The operations of 1920 may be performed in accordance with examples as disclosed herein. In some examples, aspects of the operations of 1920 may be performed by an uplink transmission component 1240 as described with reference to FIG. 12.

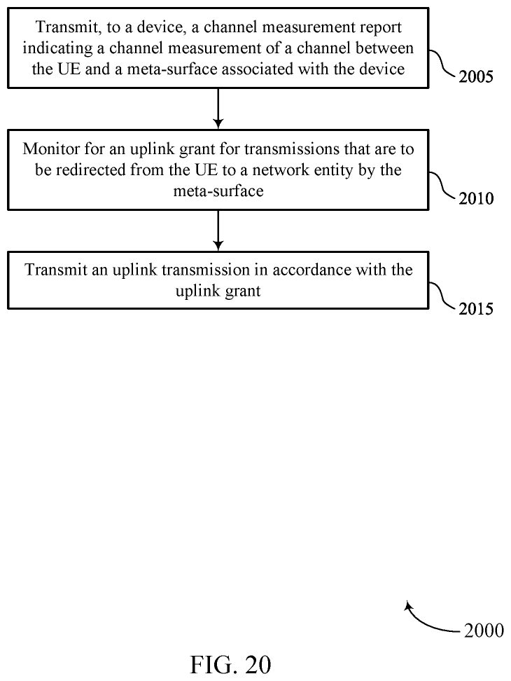

FIG. 20 illustrates a flowchart illustrating a method 2000 that supports meta-surface enabled multiple access control in accordance with one or more examples as disclosed herein. The operations of the method 2000 may be implemented by a UE or its components as described herein. For example, the operations of the method 2000 may be performed by a UE 115 as described with reference to FIGS. 1 through 5 and 14 through 17. In some examples, a UE may execute a set of instructions to control the functional elements of the UE to perform the described functions. Additionally, or alternatively, the UE may perform aspects of the described functions using special-purpose hardware.

At 2005, the method may include transmitting, to a device, a channel measurement report indicating a channel measurement of a channel between the UE and a meta-surface associated with the device. The operations of 2005 may be performed in accordance with examples as disclosed herein. In some examples, aspects of the operations of 2005 may be performed by a channel measurement component 1625 as described with reference to FIG. 16.

At 2010, the method may include monitoring for an uplink grant for transmissions that are to be redirected from the UE to a network entity by the meta-surface. The operations of 2010 may be performed in accordance with examples as disclosed herein. In some examples, aspects of the operations of 2010 may be performed by an uplink grant component 1630 as described with reference to FIG. 16.

At 2015, the method may include transmitting an uplink transmission in accordance with the uplink grant. The operations of 2015 may be performed in accordance with examples as disclosed herein. In some examples, aspects of the operations of 2015 may be performed by an uplink transmission component 1635 as described with reference to FIG. 16.

The following provides an overview of aspects of the present disclosure:

Aspect 1: A method for wireless communication at a device, comprising: receiving, from a network entity via an access link, a sidelink grant for forwarding a combined uplink grant to a plurality of user equipments (UEs); transmitting, based at least in part on the combined uplink grant, individual uplink grants to the plurality of UEs in accordance with the sidelink grant; and configuring, via a control signal, a meta-surface to redirect one or more uplink transmissions from the plurality of UEs to the network entity in accordance with the individual uplink grants.

Aspect 2: The method of aspect 1, further comprising: transmitting, to the network entity via the access link, an indication of the plurality of UEs associated with the meta-surface; and receiving, from the network entity via the access link, a combined uplink grant for the plurality of UEs.

Aspect 3: The method of any of aspects 1 through 2, further comprising: transmitting, to the network entity via the access link, a request to enable a multiple access communication scheme for the plurality of UEs via the meta-surface; and receiving, based at least in part on the request, a response message indicating that the multiple access communication scheme is enabled for the plurality of UEs, wherein transmitting the individual uplink grants is based at least in part on receiving the response message.

Aspect 4: The method of aspect 3, wherein the request further comprises an identifier associated with the device, an identifier associated with the plurality of UEs, one or more identifiers for individual UEs of the plurality of UEs, or any combination thereof.

Aspect 5: The method of any of aspects 3 through 4, wherein the request further comprises one or more channel measurement reports for one or more channels between the meta-surface and one or more UEs of the plurality of UEs.

Aspect 6: The method of any of aspects 3 through 5, further comprising: transmitting, to the plurality of UEs and based at least in part on the response message, an indication that meta-surface enabled multiple access for the plurality of UEs has been enabled.

Aspect 7: The method of any of aspects 1 through 6, further comprising: transmitting an indication of a multiple access scheme associated with the plurality of UEs.

Aspect 8: The method of any of aspects 1 through 7, wherein the combined uplink grant comprises an indication of a bandwidth part associated with the combined uplink grant, an indication of a common resource allocation, an identifier associated with the plurality of UEs, a list of UEs of the plurality of UEs that are scheduled by the combined uplink grant, a list of modulation and coding scheme orders for each UE of the list of UEs being scheduled by the combined uplink grant, an indication of the sidelink grant, or any combination thereof.

Aspect 9: The method of any of aspects 1 through 8, wherein the individual uplink grants indicate a bandwidth part for the one or more uplink transmissions, a common resource allocation for the one or more uplink transmissions, precoding information for the one or more uplink transmissions, or any combination thereof.

Aspect 10: The method of any of aspects 1 through 9, further comprising: receiving one or more measurement reports for one or more channels associated with the plurality of UEs and the meta-surface; and transmitting, to the network entity via the access link, an indication of the plurality of UEs associated with the meta-surface, wherein the indication of the plurality of UEs comprises an indication of a multiple access group that includes the plurality of UEs based at least in part on the one or more measurement reports.

Aspect 11: The method of any of aspects 1 through 10, further comprising: transmitting, to the network entity via the access link, an indication of the plurality of UEs associated with the meta-surface; and receiving one or more cell-specific identifiers associated with the plurality of UEs and one or more cell identifiers associated with the plurality of UEs, wherein the indication of the plurality of UEs comprises an indication of a multiple access group that includes the plurality of UEs based at least in part on the one or more cell-specific identifiers and the one or more cell identifiers.

Aspect 12: The method of any of aspects 1 through 11, further comprising: receiving, from the plurality of UEs, one or more meta-surface configurations for individual UEs of the plurality of UEs; wherein the control signal indicating to redirect the one or more uplink transmissions is based at least in part on the one or more meta-surface configurations.

Aspect 13: The method of any of aspects 1 through 12, wherein the device is a meta-surface controller.

Aspect 14: A method for wireless communications at a network entity, comprising: receiving, from a device via an access link, an indication of a plurality of user equipments (UEs) associated with a meta-surface controlled by the device; transmitting, via the access link, a combined uplink grant for the plurality of UEs; transmitting, to the device via the access link, a sidelink grant for relay by the device to the plurality of UEs; and monitoring for one or more uplink transmissions from the plurality of UEs via the meta-surface in accordance with the combined uplink grant.

Aspect 15: The method of aspect 14, further comprising: receiving a request to enable meta-surface enabled multiple access for the plurality of UEs, the request comprising the indication of the plurality of UEs; and transmitting, based at least in part on the indication of the plurality of UEs, a response message enabling the meta-surface enabled multiple access for the plurality of UEs.

Aspect 16: The method of aspect 15, wherein the request further comprises an identifier associated with the device, an identifier associated with the plurality of UEs, one or more identifiers for individual UEs of the plurality of UEs, or any combination thereof.

Aspect 17: The method of any of aspects 15 through 16, wherein the request further comprises one or more channel measurement reports for one or more channels between the meta-surface and the plurality of UEs.

Aspect 18: The method of any of aspects 14 through 17, further comprising: receiving an indication of a multiple access scheme associated with the plurality of UEs.

Aspect 19: The method of any of aspects 14 through 18, wherein the combined uplink grant comprises an indication of a bandwidth part associated with the combined uplink grant, an indication of a common resource allocation, an identifier associated with the plurality of UEs, a list of UEs of the plurality of UEs that are scheduled by the combined uplink grant, a list of modulation and coding scheme orders for each UE of the list of UEs being scheduled by the combined uplink grant, an indication of the sidelink grant, or any combination thereof.

Aspect 20: The method of any of aspects 14 through 19, wherein the one or more uplink transmissions comprise multiple uplink transmissions, the method further comprising: performing a successive interference cancelation process on the multiple uplink transmissions to decode one or more of the multiple uplink transmissions.

Aspect 21: A method for wireless communication at a UE, comprising: transmitting, to a device, a channel measurement report indicating a channel measurement of a channel between the UE and a meta-surface associated with the device; monitoring for an uplink grant for transmissions that are to be redirected from the UE to a network entity by the meta-surface; and transmitting an uplink transmission in accordance with the uplink grant.

Aspect 22: The method of aspect 21, further comprising: receiving a notification that uplink multiple access communications are enabled for a plurality of UEs that comprises the UE, wherein monitoring for the uplink grant is based at least in part on receiving the notification.

Aspect 23: The method of any of aspects 21 through 22, further comprising: receiving, via a sidelink channel, a channel measurement request indicating a sidelink resource for the channel measurement.

Aspect 24: The method of any of aspects 21 through 23, wherein the channel measurement report indicates a requested meta-surface configuration for the meta-surface based at least in part on the channel measurement.

Aspect 25: The method of any of aspects 21 through 24, further comprising: receiving, in accordance with a sidelink grant, the uplink grant from the device.

Aspect 26: The method of aspect 25, wherein the uplink grant includes an indication of a bandwidth part associated with the uplink grant, an indication of a common resource allocation common to a plurality of UEs that comprises the UE, precoding information for the uplink transmission, or any combination thereof.

Aspect 27: The method of any of aspects 21 through 26, further comprising: transmitting a cell-specific identifier associated with the UE and a cell identifier associated with the UE.

Aspect 28: An apparatus for wireless communication at a device, comprising a processor; memory coupled with the processor; and instructions stored in the memory and executable by the processor to cause the apparatus to perform a method of any of aspects 1 through 13.

Aspect 29: An apparatus for wireless communication at a device, comprising at least one means for performing a method of any of aspects 1 through 13.

Aspect 30: A non-transitory computer-readable medium storing code for wireless communication at a device, the code comprising instructions executable by a processor to perform a method of any of aspects 1 through 13.

Aspect 31: An apparatus for wireless communications at a network entity, comprising a processor; memory coupled with the processor; and instructions stored in the memory and executable by the processor to cause the apparatus to perform a method of any of aspects 14 through 20.

Aspect 32: An apparatus for wireless communications at a network entity, comprising at least one means for performing a method of any of aspects 14 through 20.

Aspect 33: A non-transitory computer-readable medium storing code for wireless communications at a network entity, the code comprising instructions executable by a processor to perform a method of any of aspects 14 through 20.

Aspect 34: An apparatus for wireless communication at a UE, comprising a processor; memory coupled with the processor; and instructions stored in the memory and executable by the processor to cause the apparatus to perform a method of any of aspects 21 through 27.

Aspect 35: An apparatus for wireless communication at a UE, comprising at least one means for performing a method of any of aspects 21 through 27.

Aspect 36: A non-transitory computer-readable medium storing code for wireless communication at a UE, the code comprising instructions executable by a processor to perform a method of any of aspects 21 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a device, comprising:
a processor;
memory coupled with the processor; and
instructions stored in the memory and executable by the processor to cause the apparatus to:
receive, from a network entity via an access link, a sidelink grant for forwarding a combined uplink grant to a plurality of user equipments (UEs);
transmit, based at least in part on the combined uplink grant, individual uplink grants to the plurality of UEs in accordance with the sidelink grant; and
configure, via a control signal, a meta-surface to redirect one or more uplink transmissions from the plurality of UEs to the network entity in accordance with the individual uplink grants.

2. The apparatus of claim 1, wherein the instructions are further executable by the processor to cause the apparatus to:
transmit, to the network entity via the access link, an indication of the plurality of UEs associated with the meta-surface; and
receive, from the network entity via the access link, a combined uplink grant for the plurality of UEs.

3. The apparatus of claim 1, wherein the instructions are further executable by the processor to cause the apparatus to:
transmit, to the network entity via the access link, a request to enable a multiple access communication scheme for the plurality of UEs via the meta-surface; and
receive, based at least in part on the request, a response message indicating that the multiple access communication scheme is enabled for the plurality of UEs, wherein the individual uplink grants are transmitted based at least in part on receiving the response message.

4. The apparatus of claim 3, wherein the request further comprises an identifier associated with the device, an identifier associated with the plurality of UEs, one or more identifiers for individual UEs of the plurality of UEs, or any combination thereof.

5. The apparatus of claim 3, wherein the request further comprises one or more channel measurement reports for one or more channels between the meta-surface and one or more UEs of the plurality of UEs.

6. The apparatus of claim 3, wherein the instructions are further executable by the processor to cause the apparatus to:
transmit, to the plurality of UEs and based at least in part on the response message, an indication that meta-surface enabled multiple access for the plurality of UEs has been enabled.

7. The apparatus of claim 1, wherein the instructions are further executable by the processor to cause the apparatus to:
transmit an indication of a multiple access scheme associated with the plurality of UEs.

8. The apparatus of claim 1, wherein the combined uplink grant comprises an indication of a bandwidth part associated with the combined uplink grant, an indication of a common resource allocation, an identifier associated with the plurality of UEs, a list of UEs of the plurality of UEs that are scheduled by the combined uplink grant, a list of modulation and coding scheme orders for each UE of the list of UEs being scheduled by the combined uplink grant, an indication of the sidelink grant, or any combination thereof.

9. The apparatus of claim 1, wherein the individual uplink grants indicate a bandwidth part for the one or more uplink transmissions, a common resource allocation for the one or more uplink transmissions, precoding information for the one or more uplink transmissions, or any combination thereof.

10. The apparatus of claim 1, wherein the instructions are further executable by the processor to cause the apparatus to:
receive one or more measurement reports for one or more channels associated with the plurality of UEs and the meta-surface; and
transmit, to the network entity via the access link, an indication of the plurality of UEs associated with the meta-surface, wherein the indication of the plurality of UEs comprises an indication of a multiple access group that includes the plurality of UEs based at least in part on the one or more measurement reports.

11. The apparatus of claim 1, wherein the instructions are further executable by the processor to cause the apparatus to:
transmit, to the network entity via the access link, an indication of the plurality of UEs associated with the meta-surface; and
receive one or more cell-specific identifiers associated with the plurality of UEs and one or more cell identifiers associated with the plurality of UEs, wherein the indication of the plurality of UEs comprises an indication of a multiple access group that includes the plurality of UEs based at least in part on the one or more cell-specific identifiers and the one or more cell identifiers.

12. The apparatus of claim 1, wherein the instructions are further executable by the processor to cause the apparatus to:
receive, from the plurality of UEs, one or more meta-surface configurations for individual UEs of the plurality of UEs;
wherein the control signal indicates to redirect the one or more uplink transmissions based at least in part on the one or more meta-surface configurations.

13. The apparatus of claim 1, wherein the device is a meta-surface controller.

14. An apparatus for wireless communications at a network entity, comprising:
a processor;
memory coupled with the processor; and
instructions stored in the memory and executable by the processor to cause the apparatus to:
receive, from a device via an access link, an indication of a plurality of user equipments (UEs) associated with a meta-surface controlled by the device;
transmit, via the access link, a combined uplink grant for the plurality of UEs;
transmit, to the device via the access link, a sidelink grant for relay by the device to the plurality of UEs; and
monitor for one or more uplink transmissions from the plurality of UEs via the meta-surface in accordance with the combined uplink grant.

15. The apparatus of claim 14, wherein the instructions are further executable by the processor to cause the apparatus to:
receive a request to enable meta-surface enabled multiple access for the plurality of UEs, the request comprising the indication of the plurality of UEs; and
transmit, based at least in part on the indication of the plurality of UEs, a response message enabling the meta-surface enabled multiple access for the plurality of UEs.

16. The apparatus of claim 15, wherein the request further comprises an identifier associated with the device, an identifier associated with the plurality of UEs, one or more identifiers for individual UEs of the plurality of UEs, or any combination thereof.

17. The apparatus of claim 15, wherein the request further comprises one or more channel measurement reports for one or more channels between the meta-surface and the plurality of UEs.

18. The apparatus of claim 14, wherein the instructions are further executable by the processor to cause the apparatus to:
receive an indication of a multiple access scheme associated with the plurality of UEs.

19. The apparatus of claim 14, wherein the combined uplink grant comprises an indication of a bandwidth part associated with the combined uplink grant, an indication of a common resource allocation, an identifier associated with the plurality of UEs, a list of UEs of the plurality of UEs that are scheduled by the combined uplink grant, a list of modulation and coding scheme orders for each UE of the list of UEs being scheduled by the combined uplink grant, an indication of the sidelink grant, or any combination thereof.

20. The apparatus of claim 14, wherein the one or more uplink transmissions comprise multiple uplink transmissions, and the instructions are further executable by the processor to cause the apparatus to:
perform a successive interference cancelation process on the multiple uplink transmissions to decode one or more of the multiple uplink transmissions.

21. An apparatus for wireless communication at a user equipment (UE), comprising:
a processor;
memory coupled with the processor; and
instructions stored in the memory and executable by the processor to cause the apparatus to:
transmit, to a device, a channel measurement report indicating a channel measurement of a channel between the UE and a meta-surface associated with the device;
monitor for an uplink grant for transmissions that are to be redirected from the UE to a network entity by the meta-surface; and
transmit an uplink transmission in accordance with the uplink grant.

22. The apparatus of claim 21, wherein the instructions are further executable by the processor to cause the apparatus to:
receive a notification that uplink multiple access communications are enabled for a plurality of UEs that comprises the UE, wherein monitoring for the uplink grant is based at least in part on receiving the notification.

23. The apparatus of claim 21, wherein the instructions are further executable by the processor to cause the apparatus to:
receive, via a sidelink channel, a channel measurement request indicating a sidelink resource for the channel measurement.

24. The apparatus of claim 21, wherein the channel measurement report indicates a requested meta-surface configuration for the meta-surface based at least in part on the channel measurement.

25. The apparatus of claim 21, wherein the instructions are further executable by the processor to cause the apparatus to:
receive, in accordance with a sidelink grant, the uplink grant from the device.

26. The apparatus of claim 25, wherein the uplink grant includes an indication of a bandwidth part associated with the uplink grant, an indication of a common resource allocation common to a plurality of UEs that comprises the UE, precoding information for the uplink transmission, or any combination thereof.

27. The apparatus of claim 21, wherein the instructions are further executable by the processor to cause the apparatus to:
transmit a cell-specific identifier associated with the UE and a cell identifier associated with the UE.

28. A method for wireless communication at a device, comprising:
receiving, from a network entity via an access link, a sidelink grant for forwarding a combined uplink grant to a plurality of user equipments (UEs);
transmitting, based at least in part on the combined uplink grant, individual uplink grants to the plurality of UEs in accordance with the sidelink grant; and
configuring, via a control signal, a meta-surface to redirect one or more uplink transmissions from the plurality of UEs to the network entity in accordance with the individual uplink grants.

29. The method of claim 28, further comprising:
transmitting, to the network entity via the access link, an indication of the plurality of UEs associated with the meta-surface; and
receiving, from the network entity via the access link, a combined uplink grant for the plurality of UEs.

30. The method of claim 28, further comprising:
transmitting, to the network entity via the access link, a request to enable a multiple access communication scheme for the plurality of UEs via the meta-surface; and
receiving, based at least in part on the request, a response message indicating that the multiple access communication scheme is enabled for the plurality of UEs, wherein transmitting the individual uplink grants is based at least in part on receiving the response message.
